(19) United States
(12) Patent Application Publication
(10) Pub. No.: US 2007/0033061 A1
(43) Pub. Date: Feb. 8, 2007

(54) Business methods for commercializing antimicrobial and cytotoxic compounds

(75) Inventors: Phillip A. Patten, Portola Valley, CA (US); J. Kevin Judice, El Granada, CA (US)

Correspondence Address: SEED INTELLECTUAL PROPERTY LAW GROUP PLLC, 701 FIFTH AVE, SUITE 5400, SEATTLE, WA, 98104, US

(73) Assignee: Achaogen, Inc., South San Francisco, CA (US)

(21) Appl. No.: 11/399,697

(22) Filed: Apr. 5, 2006

Related U.S. Application Data
(60) Provisional application No. 60/668,842, filed on Apr. 5, 2005.

(51) Int. Cl. G06Q 99/00; G06Q 20/00

(52) U.S. Cl. 705/1; 705/16

(57) ABSTRACT

Business methods for the commercialization of antimicrobial and cytotoxic compounds, including antibiotics and chemotherapeutic agents, are disclosed. According to one embodiment of the invention, drugs that are found to be effective but unsafe at therapeutic dosages are rescued by way of the use of an inhibitor of DNA repair, recombination, or replication, which sensitized microorganisms and cells, thereby permitting their use at a lower and safe dosage. In another embodiment, drugs that are found to be effective but cost prohibitive are rescued by way of the use of an inhibitor of DNA repair, recombination, or replication, thereby permitting their use at lower dosages and costs. A biopharmaceutical company may then, commercialize or charge royalties on such drugs.

### CROSS-REFERENCE TO RELATED APPLICATION

This application claims the benefit under 35 U.S.C. § 119(e) of U.S. Provisional Patent Application No. 60/668,842, filed Apr. 5, 2005, which is incorporated by reference in its entirety.

### BACKGROUND OF THE INVENTION

1. Field of the Invention

The present invention is directed to new business methods needed to address the growing problem of cellular resistance to antimicrobial and cytotoxic compounds. The present invention also includes new business methods to address problems related to undesirable side-effects associated with existing and new antimicrobial and cytotoxic compounds.

2. Description of the Related Art

The worldwide emergence of microorganisms that are resistant to available antimicrobial agents threatens to undo the dramatic advances in human health witnessed in the second half of the last century. This development is especially troubling considering that only one new class of antibiotics (the oxazolidinones) has been introduced in the past 35 years.

Drug resistance is also a problem during cancer therapy. It is estimated that nearly half of all cancer patients are cured, mostly by a combination of surgery, radiotherapy and/or chemotherapy. However, some cancers can only be treated by chemotherapy, and in those cases, only one in five patients survive long-term. It is believed that the overriding reason for this poor result is drug resistance, wherein the tumors are either innately resistant to the drugs available, or else are initially sensitive but evolve resistance during treatment and eventually re-grow (Allen, J. D., et al. Cancer Research 62:2294-2299 (2002)).

The healthcare establishment is countering the ever-increasing prevalence of drug resistance using two major tactics: (1) developing new antimicrobial and cytotoxic compounds; and (2) limiting the use of antimicrobial and cytotoxic compounds to extend their utility. Unfortunately, however, these efforts are hampered due to undesirable side-effects or high costs associated with antimicrobial and cytotoxic compounds, which frequently prevent the use of both known and new antimicrobial and cytotoxic compounds.

Clearly, new business methods are needed to address the growing problem of drug resistance and to increase the number of available antimicrobial and cytotoxic agents.

### BRIEF SUMMARY OF THE INVENTION

Business methods are disclosed for commercializing antimicrobial and cytotoxic compounds, including antibiotics and chemotherapeutic agents. In addition, business methods are disclosed for commercializing inhibitors of DNA repair, recombination, or replication.

### BRIEF DESCRIPTION OF THE SEVERAL VIEWS OF THE DRAWING(S)

FIG. 1 provides a diagram of the bacterial response to ciprofloxacin. In the absence of homologous sequences, free double strand breaks (DSBs) are repaired by nuclease and polymerase-dependent illegitimate recombination (IR; Pathway A). In the presence of a suitable homologous sequence and a functional homologous recombination system, free DSBs may be repaired by replication-dependant recombination (RDR; Pathway B). This pathway may also contribute to the repair of replication forks when they encounter the free DSB. Finally, inhibited replication forks are repaired by recombination-dependent fork repair (Pathway C).

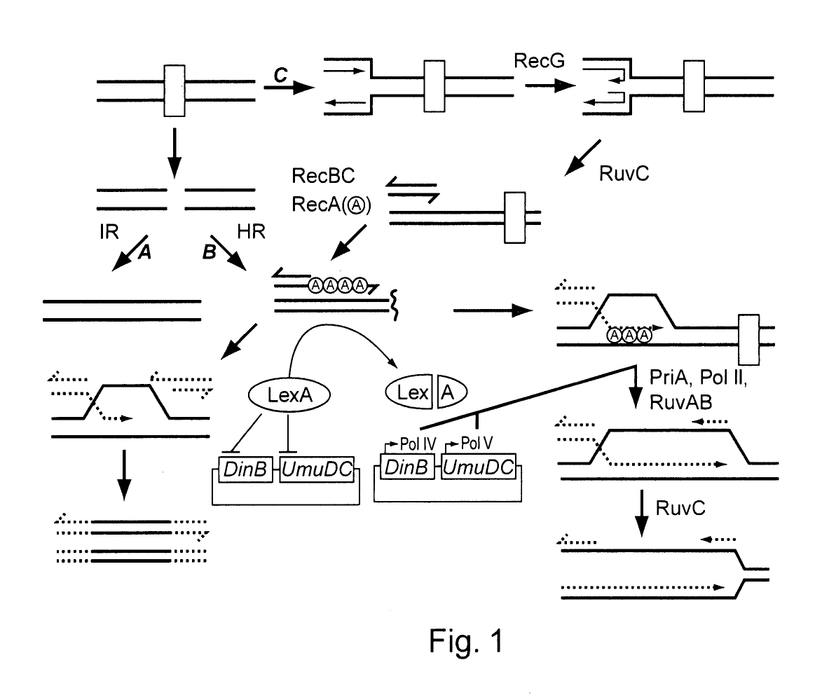

FIG. 2 is a graph depicting the number of viable cells remaining at the indicated time points following plating of various recombination mutants on solid media containing 40 ng/ml ciprofloxacin.

FIG. 3 illustrates a stressful lifestyle adaptive mutation (SLAM) assay.

FIG. 4 is a graph depicting the number of viable cells remaining at the indicated time points following plating of wild-type and mutant strains on solid media containing 40 ng/mL ciprofloxacin. FIG. 4A depicts recombination mutants that were hypersensitive to ciprofloxacin and FIG. 4B depicts recombination mutants with wild-type sensitivity. Values represent the number of cells surviving per day, and error bars represent standard deviation from at least three independent determinations.

FIG. 5 is a graph depicting the minimum inhibitory concentration (MIC) of various temperature sensitive recB mutant strains of SK119 under permissive and non-permissive conditions. SK119 indicates the wild-type SK119 strain; 1, 3, 5, 6, and 8 each indicate separate strains of ciprofloxacin resistant mutants that were selected at the permissive temperature, as described in Example 3.

FIG. 6 is a graph depicting the effect of deletion of recB on the ciprofloxacin sensitivity of Kleibsiella Pneumoniae in a murine thigh infection model. The graph shows the log cfu/g of thigh muscle in animals infected with wild type or recB mutant strains of Kleibsiella Pneumoniae at various dosages of ciprofloxacin.

### DETAILED DESCRIPTION OF THE INVENTION

The emergence of drug resistant microorganisms and cells is an increasing threat to human health and to the financial health of businesses that discover, develop, market, and sell therapeutic drugs, including antibiotics and chemotherapeutic agents. In addition, undesirable side-effects resulting from the administration of drugs at therapeutic dosages frequently prevent their use, either entirely, or at least for certain indications or in certain patient populations, thereby reducing the available market. Similarly, the high cost of certain drugs discourages physicians from prescribing these drugs when lower cost alternatives are available, thus further reducing sales.

The invention herein provides methods that enable increased business opportunities for the discovery, development, marketing, and sales of antimicrobial and cytotoxic agents. In addition, the invention provides new business opportunities stemming from the discovery of compounds that enhance the sensitivity of microorganisms and cells to antimicrobial and cytotoxic agents, and/or are cytotoxic for drug-resistant microorganisms and cells, thereby effectively increasing the therapeutic index of a variety of antimicrobial and cytotoxic agents.

The present invention is based, in part, on the fundamental discoveries related to mechanisms of drug sensitivity and resistance that are described in provisional U.S. patent application Ser. No. 60/668,737, entitled, “Compositions and Methods for Enhancing Drug Sensitivity and Treating Drug Resistant Infections and Disease,” which is herein incorporated by reference in its entirety. This discovery establishes that inhibition of DNA repair, recombination, or replication pathways enhances the sensitivity of microorganisms and cells to antimicrobial and cytotoxic compounds, including antibiotics such as ciprofloxacin and chemotherapeutic agents such as topoisomerase poisons. In addition, inhibition of DNA repair, recombination, and replication pathways causes reduced proliferation and/or increased death of drug resistant microorganisms and cells. Accordingly, compounds that inhibit DNA repair, recombination, or replication are, themselves, drugs that may be used alone or in combination with an antimicrobial or cytotoxic agent to treat drug resistant microorganisms and cells, or to enhance the sensitivity of a drug resistant or drug sensitive cell to an antimicrobial or cytotoxic agent.

The present invention provides new business methods related to the use and sale of inhibitors of DNA repair, recombination, or replication. These inhibitors may be used and sold by companies that discover, develop, market, or sell antimicrobial or cytotoxic compounds, including antibiotics and chemotherapeutic agents, or they may be used and sold by separate companies. Such business methods are useful for a wide range of applications, including the preclinical and clinical development of antimicrobial and cyotoxic agents, and the marketing and sale of new and existing antimicrobial and cytotoxic agents. In addition, these methods are useful in developing, marketing, and selling new drugs, since the inhibitors described herein are themselves useful drugs for the treatment of drug resistant microorganisms and cells. While a major market of inhibitors of DNA repair, recombination, or replication lies in the medical treatment of humans, further business opportunities exist in other industries, such as veterinary medicine and the manufacture of antimicrobial products used in cleaning supplies and by food preparation industries.

In one embodiment, methods of the invention are applied to drugs that have not yet received marketing approval by an appropriate government agency, e.g., the Food and Drug Administration (FDA), to treat one or more indications or patient populations, due to undesirable side-effects associated with the use of the drug at a therapeutically effective dosage. Such drugs may have actually failed to receive approval after submission of an application for marketing approval, or such drugs may have been abandoned during the course of development. By enhancing cellular sensitivity to antimicrobial and cytotoxic agents, inhibitors of DNA repair, recombination, or replication effectively reduce a therapeutic index of such drugs, thereby allowing the use of lower dosages with a reduced risk or severity of associated side-effects.

The ratio of the drug dose that produces an undesired effect to the dose that causes the desired effects is a therapeutic index and indicates the selectivity of the drug and consequently its usability. It should be noted that a single drug can have many therapeutic indices, one for each of its undesirable effects relative to a desired drug action, and one for each of its desired effects if the drug has more than one action. Accordingly, by using an inhibitor of the present invention in combination with a drug, thereby enhancing the sensitivity of a microorganism or cell to the drug and, thus, decreasing the drug dose required for a desired effect, the present invention provides a method of increasing a therapeutic index.

It has been estimated that the average cost to create a clinical candidate is $15 million-$25 million. As such, approval failures resulting from side-effects can cost as much as $25 million per failure, which creates a significant burden for companies involved in drug discovery. In addition, many drugs are plagued by the emergence of resistance during the course of clinical development or even well into their lives as marketed drugs, creating an even greater financial burden for a company that pursues such compounds.

Thus, in one embodiment, the invention includes the business method of achieving marketing approval and selling an antimicrobial or cytotoxic agent, by combining the use of the antimicrobial or cytotoxic agent with the use of an inhibitor of DNA repair, recombination, or replication.

In a related embodiment, the invention includes a business method of selling a drug previously approved for a limited number of conditions or patient populations to a new market, by achieving marketing approval for additional uses, based upon the ability to use the drug in combination with an inhibitor of DNA repair, recombination, or replication, thereby reducing the dosage of drug used. For example, the use of fluoroquinolones, e.g., ciprofloxacin, is generally avoided in pediatric patients due to potential cartilage damage. The ability to use lower dosages in combination with an inhibitor of the present invention permits the use of such drugs in pediatric patents.

In another embodiment, the present invention provides a method of business comprising increasing the market and sales of a drug approved for treating a particular disease or condition, by selling the drug for use in combination with an inhibitor of DNA repair, recombination, or replication, wherein said drug is used at a lower dosage in the combination as compared to when used alone. Since microorganisms and cells are sensitized to the drug when it is used in combination with the inhibitor, lower dosages may be used, leading to lower costs. Accordingly, the drug will be more competitively priced as compared to alternatives, and a larger amount of drug will be sold.

It is understood that the business methods described herein apply to selling a drug in combination with an inhibitor, and to selling either a drug or inhibitor for use in such a combination. For example, in certain embodiments, a company may identify and sell an inhibitor that reduces the therapeutic index of one or more drugs and then market and sell the inhibitor to be prescribed in combination with these drugs. Similarly, a company may market and sell a drug for use at a lower dosage than previously used, and in combination with an inhibitor of DNA repair, recombination, or replication. Alternatively, a company may sell an inhibitor in combination with a drug. It is further understood that the term “sell” also encompasses licensing and all other forms of rights transfer.

In one embodiment of the invention described herein, an acquiring company licenses or otherwise acquires the rights to a drug candidate from an organization that, because of the undesirable side-effects associated with said candidate, might not pursue the candidate (at least for certain indications or uses). In this embodiment of the invention, the candidate is “rescued” as a result of the availability of an inhibitor of DNA repair, recombination, or replication that might be utilized in combination with the candidate.

In yet a further related embodiment, an acquiring company licenses or otherwise acquires the rights to a drug from an organization that, because of the predicted high market price of the drug as compared to the market price of alternative drugs, might not pursue the drug.

In these embodiments of the invention, the business arrangement between the acquiring company and the licensing organization may provide for the acquiring company to acquire intellectual property rights to such drugs, along with, in some cases, associated technical information. The acquiring company would pay the licensing organization some combination of upfront fees, ongoing research and development payments, milestone payments (upon, for example, the acquiring company achieving clinical development, revenue creation, or technical success milestones) and other consideration. The payments may be in the form of, for example, cash, equity, or traded assets (including, for example, rights to other drugs).

In return, the organization owning the rights to the drugs, in some embodiments, would grant exclusive or non-exclusive licenses to the intellectual property rights associated with the drugs, or assign the intellectual property rights associated with such drugs to the acquiring company. The rights may be granted in-toto or in specific fields or territories, such as in combination with a specifically named inhibitor of DNA repair, recombination, or replication, classes of inhibitors of DNA repair, recombination, or replication, or inhibitors of DNA repair, recombination, or replication to be developed. In some cases, the organization granting the rights to the drug would retain rights to make, use, or sell the drug in co-formulations not developed by the acquiring company.

In some cases, the organization granting the rights to the drug would retain the right to market and/or co-market an inhibitor of DNA repair, recombination, or replication co-formulation developed by the acquiring company in a particular geographic region (e.g., Asia). In other embodiments, the acquiring company might grant the licensing organization a time-limited buy-back option to re-acquire rights to licensed drugs, in some cases for use in association with the inhibitor of DNA repair, recombination, or replication, such as for use in a combination therapy. In such situations, the acquiring company may receive higher royalty rates, milestones, and other fees in return for having moved the drug closer to commercialization in combination with an inhibitor of DNA repair, recombination, or replication.

The acquiring company may grant the rights back subject to, for example, retained geographic marketing rights, and may retain the right to manufacture/supply the inhibitor of DNA repair, recombination, or replication for use with the drug. For example, the acquiring company may retain the right to manufacture and provide to the company exercising it buy-back right an inhibitor of DNA repair, recombination, or replication in those situations where the licensing organization exercises a buy back right or a right to sell in a particular territory.

In alternative embodiments, the company holding the rights to the drug collaborates with a company holding rights to an inhibitor of DNA repair, recombination, or replication, and/or licenses rights to use the inhibitor of DNA repair, recombination, or replication in combination with one or more of its drugs. In this case, the company holding the rights to the drug retains its intellectual property rights, but may provide compensation to the inhibitor of DNA repair, recombination, or replication provider in the form of, for example, research funding, milestones, and/or royalties on the antibiotic/inhibitor of DNA repair, recombination, or replication combination. The company holding rights to the inhibitor of DNA repair, recombination, or replication may retain the right to manufacture the inhibitor of DNA repair, recombination, or replication, or there may be a mix of all the above rights such as where, for example, the company holding rights to the inhibitor of DNA repair, recombination, or replication obtains jurisdictional marketing rights to the underlying drug.

Another business threat to the sales of drug compounds that are already on the market due is patent expiration. Sales of popular drug products often fall when the patent on such drug expires. Because the co-formulation (or co-administration) of drugs with an inhibitor of DNA repair, recombination, or replication may represent a newly patented composition (or method), this threat to the drug franchise is addressed according to business methods of the invention. Patents may be obtained on the combination of a drug and an inhibitors, thereby extending patent rights associated with the drug. Patent positioning (through combination patents) is, thus, significantly improved. In these embodiments, some or all of the same financial arrangements used in the drug rescue embodiments described above may be employed. For example, the inhibitor of DNA repair, recombination, or replication provider may license the rights to the inhibitor to the company marketing the drug, or may supply and/or co-market the inhibitor with the drug. In some cases, the company holding the rights to the inhibitor may receive license fees, research funding, milestone payments, and/or up front payments, as well as, for example, territorial marketing rights to the drug. In yet another embodiment of this invention, a company does not partner its inhibitor-off patent drug co-formulation. In this embodiment, a company maintains its ownership of the asset, progresses the co-formulation through clinical trials, and then launches the co-formulation as a proprietary product.

Some co-formulations of inhibitors of DNA repair, recombination, or replication with drugs (e.g., co-formulations with Avelox®, Tequin®, Factive®, Ketek®, Levaquin®, Desquinolone™, Cipro®, Biaxin®, etc.) are best suited for the treatment of community infections (e.g., UTI's, gonorrhea, strep throat, etc.). In the case where a company owning an inhibitor of DNA repair, recombination, or replication “rescues” a community drug but does not develop its own community-focused sales force, it may partner its “rescued” community antibiotic(s) with large pharmaceutical companies. Large pharmaceutical companies maintain large community-focused sales forces (composed of thousands of salespeople) to sell into the general practitioner market throughout the US and Europe. Because accessing the hospital market, however, only requires a relatively small sales force (75-100 salespeople), a company owning an drug-inhibitor co-formulation may in certain cases prefer to retain the rights for its own marketing (or co-marketing) to “rescued” drugs best suited for the treatment of hospital infections, such as Methicillin-resistant Staph aureus (MRSA), Vancomycin-resistant enterococcus (VRE), or multi-drug resistant pneumonia. Such drugs include rifampicin™ (rifampin™), streptomycin®, novobiocin™, gentamicin®, tobramycin®, and spectinomycin™.

The present invention also provides new business methods stemming from the ability of an inhibitor of DNA repair, recombination, or replication to kill drug-resistant microorganisms or cells. In one embodiment, such a business method includes identifying an inhibitor and marketing and selling the inhibitor for the treatment of a drug resistant microorganism or cell. In certain embodiments, rights to make and/or sell the inhibitor are licensed to another company.

The importance of addressing the problem of drug resistance and drug side-effects is not unique to human therapeutics. For example, food-producing animals are given antibiotic drugs for therapeutic, prophylactic, or production applications. However, these drugs can cause microbes to become resistant to those drugs, or to drugs used to treat human illness, ultimately making some human sicknesses harder to treat. In addition, the use of such drugs may have undesired side-effects that reduce the commercial value of the animals. Any of the embodiments of the invention described herein could be applied to businesses with an interest in animal health.

Industrial applications for inhibitors of DNA repair, recombination, or replication technology may also be used in some embodiments. For example, a company holding the rights to an inhibitor of DNA repair, recombination, or replication may license or supply the inhibitor of DNA repair, recombination, or replication to an organization that produces cleaning supplies, or health or cosmetic products.

Scientific Basis

The business methods of the present invention are based, in part, on the discovery that DNA repair, recombination, and replication pathways play a fundamental role in the establishment and maintenance of drug resistance, as well as drug sensitivity of microorganisms and cells. Accordingly, inhibitors of these processes- generally possess the ability to enhance the sensitivity of a microorganism or cell to an antimicrobial or cytotoxic agent and/or are cytotoxic for a drug-resistant microorganism or cell.

Without wishing to be bound to a particularly theory, the present invention establishes that microorganisms and cells utilize a variety of DNA repair pathways to repair different forms of DNA damage caused by antimicrobial and cytotoxic agents, e.g., double-stranded DNA breaks and stalled replication forks, thereby permitting a microorganism or cell to survive in the presence of such antimicrobial and cytotoxic agents. Therefore, treating a cell with an inhibitor of a DNA repair or replication pathway enhances its sensitivity to an antimicrobial or cytotoxic agent, including those that cause DNA damage or interfere with DNA replication or repair.

A number of antimicrobial and cytotoxic agents function by interfering with DNA replication or repair, or by causing DNA damage, either directly or indirectly. Two major forms of DNA damage caused by antimicrobial and cytotoxic agents are: (1) double-stranded DNA breaks and (2) stalled replication forks.

For example, fluoroquinolones (FQs), e.g., ciprofloxacin®, function by interfering with the bacterial type II DNA topoisomerases, DNA gyrase and topoisomerase IV (Drlica, K., and Zhao, X., Microbiol Mol Biol Rev. 61:377-392 (1997)). Both of these topoisomerases function by forming protein-bridged DNA double strand breaks (DSBs), manipulating DNA strand topology, and finally rejoining the ends of the DNA. Ciprofloxacin and other FQs reversibly bind to the protein-bridged DSB intermediates and inhibit the rejoining of the DNA ends. Cell death results from the creation of free DSBs when the topoisomerase dissociates from the DNA without rejoining the DNA ends (Drlica, K., and Zhao, X., Microbiol Mol Biol Rev. 61:377-392 (1997)) and/or when DNA replication is inhibited by covalent DNA-protein complexes (Khodursky, A. B. and Cozzarelli, N. R., J. Biol. Chem. 273:27668-27677 (1998)).

In addition, certain other antimicrobial and cytotoxic agents, such as trimethoprim, cause DNA damage by interfering with thymine biosynthesis, in a process referred to as “thymineless death,” which involves both single- and double-stranded DNA breaks. DNA damaged by thymine starvation is a substrate for DNA repair processes, including recombinational repair. Mutations in recBC(D) recombinational repair genes increase sensitivity to thymineless death (Ann. Rev. Microbiol. 52:591-625 (1998)).

Microorganisms and cells possess a variety of different DNA repair mechanisms and pathways, including both homologous and non-homologous recombination-mediated pathways, in addition to non-recombination-based pathways. These DNA repair pathways are utilized during both normal cellular processes, such as DNA replication, as well as in response to DNA damaging agents, such as antimicrobial and cytotoxic compounds. Accordingly, an inhibitor may target any DNA repair or replication pathway, in any microorganism or cell, including, e.g., mammalian cells.

Repair of double-stranded DNA breaks is accomplished, in certain instances, via homologous recombination-mediated double-stranded break repair, including, e.g., RecBC(D)-mediated homologous recombination and RecFOR-mediated homologous recombination, non-homologous recombination-mediated double-stranded DNA break repair, and non-homologous end joining. In addition, repair or rescue of stalled replication forks is accomplished, in certain instances, via recombination-dependent replication fork repair and primosome reassembly. During DNA synthesis, replication fork progression on chromosomes can be impeded by DNA lesions, DNA secondary structures, or DNA-bound proteins. Elements interfering with the progression of replication forks have been reported to induce rearrangements and/or render homologous recombination essential for viability, in all organisms from bacteria to human.

Bacteria (and other microorganisms and cells) respond to low concentrations of DSBs using several DNA repair pathways. If homologous DNA is present, as is the case in a significant percentage of cells in a bacterial population, bacteria can repair DSBs by homologous recombination (HR), including HR mediated by either RecBC(D) or RecFOR.

RecBC(D) is a heterotrimeric protein complex resulting from the association of RecB, RecC, and RecD. The RecBC(D) nuclease/helicase loads at the DSB and simultaneously degrades and unwinds the duplex while loading RecA onto the single-stranded DNA (ssDNA) of the nascent 3′-overhang. In this context, RecA forms filaments that promote strand invasion of the ssDNA into a homologous sequence, ultimately restoring an intact chromosome through a synthesis-dependent strand annealing, or DSB repair-like mechanism (Aguilera, A., Trends Genet. 17:318-21 (2001)).

RecFOR is a heterotrimeric protein complex composed of RecF, RecO, and RecR. RecF helps load RecA onto ssDNA, and RecO and RecR appear to play accessory roles. While this pathway appears less able to mediate HR in response to ciprofloxacin, and is generally associated with additional mutations in sbcA, sbcB, and sbcC, it is a pathway involved in processing the damage that underlies UV sensitivity and “thymineless death.”

Additionally, bacteria (and other organisms and cells) respond to low concentrations of proteins bound to DNA, thereby inhibiting DNA replication, by recombination-dependent replication fork repair, which is a variant of HR (McGlynn, P., Lloyd, R. G., and Marians, K. J., Proc Natl Acad Sci USA., 98:8235-8240 (2001)). For example, one consequence of inhibition of type II topoisomerase by fluoroquinolones, such as ciprofloxacin, is the stalling of replication forks when they encounter the fluoroquinolone:topoisomerase:DNA complex. These stalled forks are repaired by recombination-dependent replication fork repair. The stalled forks are regressed, possibly by RecG (Robu, M. E., Inman, R. B., and Cox, M. M., J Biol. Chem., 279:10973-10981 (2004) and McGlynn, P., and Lloyd, R. G., Trends Genet., 18:413-419 (2002)) to form a Holliday junction-like structure that is recognized and cleaved by RuvC (Lovett, S. T., Hurley, R. L., Sutera, V. A. Jr, Aubuchon, R. H., Lebedeva, M. A., Genetics, 160:851-9 (2002)) to produce a double stranded end (DSE) and a nicked double stranded duplex. After the DSE is processed by RecBC(D), a RecA-ssDNA filament is formed that invades the homologous region of the nicked duplex. The resultant D-loop structure contains a primed template capable of initiating what will become leading strand synthesis of a new replication fork. An important step in the process of recombination-dependent replication fork repair is replication restart, or primosome reassembly, which is primed by the primosome complex. The primosome consists of DNAG primase, DNAB helicase, PriA, PriB, PriC, DNAC, and DNAT.

These repair strategies, many of which rely heavily on the function of the RecBC(D) helicase/nuclease complex, are thought to enable bacterial survival in the presence of low concentrations of antimicrobial and cytotoxic agents that cause DNA damage, such as ciprofloxacin. Resistance to higher concentrations requires multiple stepwise mutations in chromosomal genes (Drlica, K., and Zhao, X., Microbiol Mol Biol Rev. 61:377-392 (1997); Gibreel, A., et al., Antimicrob. Agents Chemother. 42:3276-3278 (1998); Kaatz, G. W., Seo, S. M., and Ruble, C. A., Antimicrob. Agents Chemother. 37:1086-1094 (1993); Yoshida, H., et al., J. Bacteriol. 172: 6942-6949 (1990); Poole, K., Antimicrob. Agents Chemother. 44:2233-2241 (2000); Kern, W. V., Oethinger, M., Jellen-Ritter, A. S., and Levy, S. B., Antimicrob Agents Chemother. 44:814-820 (2000); and Fukuda, H., Hori, S., and Hiramatsu, K., Antimicrob. Agents Chemother. 42:1917-1922 (1998)). Indeed, virtually all bacterial resistance to ciprofloxacin results from mutations in chromosomal genes (Everett, M. J., Jin, Y. F., Ricci, V., and Piddock, L. J. V., Antimicrob. Agents Chemother. 40:2380-2386 (1996); Deguchi, T., et al., Antimicrob. Agents Chemother. 41:1609-1611 (1997); Kanematsu, E., Deguchi, T., Yasuda, M., Kawamura, T., Nishino, Y., and Kawada, Y., Antimicrob. Agents Chemother. 42:433-435 (1998); and Wang, T., Tanaka, M., and Sato, K., Antimicrob. Agents Chemother. 42:236-240 (1998)). This is also the case for other synthetic and semi-synthetic antibiotics such as Rifampicin. Of the many resistance cases studied, clinical resistance to FQs by plasmid transfer has been reported only once (Martinez, J. L., Alonso, A., Gómez-Gómez, J. M., and Baquero, F., J. Antimicrob. Chemother. p. 42 (1998)). However, the plasmid alone imparted only a low level of resistance to ciprofloxacin, and chromosomal mutations were still required to attain high, clinically relevant resistance.

The location and nature of many of the ciprofloxacin (and other FQs) resistance-conferring mutations have been characterized and occur in the “quinolone resistance determining region” (QRDR). The primary mutations conferring resistance occur in two genes encoding the two molecular targets of ciprofloxacin, including, e.g., the gyrA gene encoding the alpha subunit of DNA gyrase (typically, the primary target in gram-negative bacteria such as E. coli, N. gonorrhoeae, K. pneumoniae, and C. trachomatis) or in the parC gene, encoding a subunit of topoisomerase IV (typically, the primary target in gram-positive bacteria including S. aureus, S. pneumoniae, and E. faecalis). The highest resistance, however, is conferred by mutations in both genes, combined with mutations in genes affecting outer membrane permeability or export through an active efflux system (Köhler, T., et al., Antimicrob. Agents Chemother. 41:2540-2543 (1997)).

Importantly, the specific residues of gyrA (i.e., S83 and D87) and parc (i.e., S80) that are frequently mutated in response to FQ selection are similar in both gram negative and gram positive bacteria. Thus, the observations described herein for E. coli may be generalized to other bacterial species.

Because the QRDR of gyrA and/or parC genes correspond to the DNA binding site of the topoisomerases, in addition to preventing ciprofloxacin binding, the mutations also interfere with DNA binding. Without wishing to be bound to a particular theory, it is understood according to the present invention that these mutations also cause the topoisomerases to prematurely dissociate from the DNA before rejoining the cleaved DNA strands. Thus, these mutations impose a liability on the cells harboring them by creating DSBs that must be repaired by HR, thereby making these cells dependent on RecBC(D) for viability. This is consistent with the data of Gari et al. (Gari, E., Bossi, L., and Figueroa-Bossi N., Genetics 159:1405-1414 (2001)), which demonstrates that a temperature sensitive allele of gyrA that mimics low level quinolone treatment at the nonpermissive temperature due to compromised gyrase activity are highly dependent on RecA and RecBC(D) for viability at the nonpermissive temperature.

Therefore, as described generally above, aspects of the present invention are based, in part, on the discovery that E. coli having mutations associated with antibiotic resistance (e.g., gyrA and parc mutations) utilize double-stranded DNA break repair and stalled replication fork repair pathways, including, e.g., RecBC(D)-mediated HR-based DNA repair, for survival. Without being bound to any one molecular interpretation, it is understood that while these mutations confer antibiotic resistance, they also compromise their encoded enzyme's ability to carry out its normal functions. Accordingly, HR-based DNA repair, recombination, and replication restart pathways are important for the survival of microorganisms and cells having compromised gyrase and topoisomerase activities, including those associated with drug resistance.

Furthermore, certain aspects of the present invention are based upon the related discovery that RecBC(D)-mediated HR and replication restart (including primosome reassembly) are important for bacterial survival at even low levels of fluoroquinolones (i.e., at or below the MIC or MBC), and establish that inhibition of double-stranded DNA break repair, e.g., RecBC(D)-mediated homologous recombination, or stalled replication fork rescue or repair, e.g., recombination-dependent replication fork repair and primosome reassembly, causes bacteria to become hypersensitive to certain antimicrobial agents.

As described in detail in the Examples section, the fundamental discoveries underlying the present invention were first made using the model organism E. coli, by probing the interdependence of gyrase, homologous recombination enzymes, and ciprofloxacin. For instance, as detailed in Example 4, a strain containing a temperature sensitive mutant of RecBC(D) was used to demonstrate that drug-resistant cells are more sensitive to drug when RecBC(D) activity is impaired. In addition, E. coli strains containing mutations in RecB, RecA, or PriA were also increasingly sensitive to fluoroquinolones (Examples 1 and 2).

Of course, it is understood that these findings in E. coli are not limited to this bacterial species. A variety of other bacterial species contain recBC(D) homologues, including, e.g., P. aeuruginosa, Salmonella, S. pneumoniae, S. aureus, methicillin resistant S. aureus or B. anthracis. Accordingly, treatment with an inhibitor of a DNA repair or replication pathway, e.g., RecBC(D)-mediated homologous recombination or replication restart, in combination with ciprofloxacin or other FQs, or other DNA damaging agents, would also kill these strains, whether they had evolved to be, or were engineered to be, resistant to such DNA damaging agents. In addition, inhibitors of DNA repair or replication should also sensitize these species to antimicrobial agents.

In addition, while the present invention stems from discoveries first made in bacteria, it is clearly applicable to other cells and organisms, including mammals. Basic mechanisms and certain components of DNA repair, recombination, and replication pathways are generally conserved from bacteria to eukaryotic cells. In addition, mechanisms of drug action and the acquisition and maintenance of drug resistance, are also shared from bacteria to eukaryotic cells. Thus, the mechanisms of combating drug resistant microorganisms and enhancing drug sensitivity described herein, exemplified in the context of bacteria, are applicable to a wide range of microorganisms and eukaryotic cells, including mammalian cells.

The fundamental role of DNA repair, recombination, and replication pathways in maintaining cell viability in the presence of mutations associated with drug resistance, or in the presence of drugs that interfere with DNA replication or repair, or cause DNA damage, as discovered according to the present invention, combined with the knowledge of these pathways and their components in many cells types, e.g., bacteria, fungi, and mammalian cells, provides a sound scientific basis for applying the compounds and methods of the present invention to treat a wide variety of drug-resistant microorganisms and cells, and also enhance drug sensitivity of various microorganisms and cells, including mammalian cells.

Indeed, impaired activity of topoisomerases has been shown to result in an increased reliance on HR in eukaryotes, in addition to prokaryotes. HR has been extensively studied in the model organism S. cerivisae. In the case of a DSB, the MRX complex (comprised of Mre11, Rad50 and Xrs2) first binds and then recruits the Tel1 checkpoint kinase via an interaction between Xrs2 and Tel1. The MRX complex is required to process ‘dirty’ DSEs, such as those that arise in response to ionizing radiation, but not those resulting from endonuclease activity. The MRX complex then dissociates and 5′-3′ resection is initiated by an unknown nuclease(s), producing a 3′-overhang that is coated with replication protein A (RPA), which acts to preserve the integrity of the 3′-overhang until it is displaced during S-phase by Rad52. Rad52 plays a central role in single-strand annealing (SSA), gene conversion (GC), and break induced recombination (BIR). If the exposed ssDNA overhangs contain sufficient homology, Rad52, possibly along with its homolog Rad59, facilitates repair by SSA. For GC and BIR, Rad52 recruits Rad51, the homolog of the bacterial recombination mediator RecA, to DSEs where it catalyzes strand invasion of a homologous duplex with concomitant displacement of the strand of the same polarity (forming an intermediate referred to as a displacement structure or D-loop). The invading strand primes DNA synthesis using the homologous sequence, ultimately creating an intact sequence at the site of a break or restoring a processive replication fork. While the activities of Rad54, Rad55, and Rad57 are sometimes not required, they appear to mediate the most efficient forms of HR, possibly by helping to stabilize Rad52-ssDNA nucleoprotein filaments. The helicases Srs2 and Sgs1 are understood to help form suitable recombination intermediates and/or to help resolve these intermediates after recombination-dependant DNA replication.

In mammalian cells, HR is an important mechanism for repairing blocked or stalled replication forks and is thought to play an important role in the repair of double-stranded DNA breaks. Consequently, inhibitors of proteins such as Rad52, Rad55, BRACA1, and BRACA2 are predicted to synergize with DNA damaging agents, topoisomerse poisons and other agents that lead to blockage of replication forks. Inhibition of the production of these proteins by, e.g., RNAi-based mechanisms, should have similar effects.

Of course, not all DNA repair pathways are mediated by HR. Additional aspects of the present invention are based on the understanding that nonhomologous end joining (NHEJ) or nonhomologous recombination (NHR) are major mechanisms for repair of DSB in mammals. NHEJ generally repairs DSB by performing a microhomology search for regions with microhomology (about 3 to 10 bases) to a DSB and by repairing the lesion in a NHR reaction. Major components of this pathway are DNA protein kinase (DNA-PK), the Ku70 and Ku86 proteins, and the XRCC4 protein. The Ku proteins form a heterodimeric helicase that binds with high affinity to double stranded ends of DNA and recruits DNA-PK. Subsequently, Ku unwinds the DNA and promotes repair either by homology dependent or homology independent pathways (Rathmell and Chu, DNA Double-Strand Break Repair, Chapter 16 or Nickoloff, J. A. and Hoekstra, M. F. in DNA Damage and Repair, Humana Press, Totowa, N.J., 1998). Cells deficient in XRCC4, Ku86 or DNA-PK are hypersensitive to ionizing radiation.

As this is a major pathway for DSB repair in mammals, inhibitors of proteins this pathway are predicted to hypersensitize cells to DNA damaging agents that cause DSB. Inhibitors of the Ku proteins (Ku70 and Ku86), DNA-PK or XRCC4 are understood to sensitize mammalian cells to DNA damaging agents and, thus, may be used in combination with treatment regimes, such as treatment with chemotherapeutics or ionizing radiation, that generate DNA damage, to enhance treatment sensitivity or kill resistant cells.

In addition, the observation that topoisomerases that have accumulated mutations in response to topoisomerase poisons show an increased reliance on mechanisms that repair DSB and stalled replication forks, due to an elevated level of DSB and stalled replication forks in cells harboring such mutant topoisomerases, may be generalized to eukaryotes. In this regard, such effects are expected to be dominant and, thus, eukaryotic cells bearing somatically selected mutations in their topoisomerases are sensitive to drugs that inhibit the relevant repair pathways.

The business methods of the present invention may be applied to a broad spectrum of inhibitors of DNA repair, recombination, or replication, including inhibitors of any of the DNA replication or repair pathways or mechanisms referred to herein, any and all of which may be used to inhibit one or more activities of a polypeptide associated with DNA repair, recombination, or replication. Furthermore, these methods may be used in business ventures based upon combating drug-resistant microorganism and cells, and/or enhancing the sensitivity of both sensitive and resistant cells to antimicrobial and cytotoxic agents, including, e.g., antibiotics and chemotherapeutics.

The business methods of the present invention are applicable to a broad range of drug-resistant and sensitive microorganisms and cells, including, e.g., bacteria, viruses, fungi, protozoa and eukaryotic cells of higher organisms, such as mammals. In addition, the invention is applicable to a wide variety of antimicrobial and cytotoxic agents or compounds, including, but not limited to, those that target cellular components of a DNA replication, recombination, or repair pathway or cause DNA damage, either directly or indirectly.

Inhibitors

As described herein, DNA repair, recombination, and replication pathways play a fundamental role in both drug resistance and drug sensitivity, and inhibition these pathways can both enhance drug sensitivity and kill drug resistant microorganisms and cells. Accordingly, the compositions and methods of the present invention are directed to any and all inhibitors of a DNA repair, recombination, or replication pathway, or polypeptide associated with such a pathway. In particular aspects of the present invention, therefore, an inhibitor targets a pathway associated with the repair of double-stranded DNA breaks, or an inhibitor targets a pathway associated with the repair of stalled replication forks. In certain, more specific embodiments related to double-stranded DNA break repair, an inhibitor targets homologous recombination, non-homologous recombination or non-homologous end joining. Specific embodiments of homologous recombination include, but are not limited to, RecBC(D)-mediated homologous recombination and RecFOR-mediated homologous recombination. Specific embodiments of stalled replication fork rescue or repair include, but are not limited to, recombination-dependent replication fork repair, recombination, and replication restart (or primosome reassembly).

In certain embodiments, an inhibitor targets a polypeptide associated with a DNA replication, recombination, or repair pathway involving homologous recombination. However, in other embodiments, an inhibitor targets a polypeptide associated with a DNA repair, recombination, or replication pathway that does not involve homologous recombination. Inhibitors of the present invention that reduce the activity of one or more polypeptide associated with either homologous recombination or non-homologous recombination may be referred to as “recombinicides.” In particular embodiments, the present invention is directed to inhibitors of RecBC(D)-mediated homologous recombination, RecFOR-mediated recombination, homologous recombination-mediated DNA repair, recombination-dependent replication fork repair, replication restart or primosome reassembly, gene conversion, single-strand annealing, break-induced recombination, and/or non-homologous end joining, and polypeptides associated with any of these pathways. As used herein, the term DNA repair or replication encompasses, but is not limited to, any and all of these biological pathways.

In general, inhibitors act by reducing the activity or expression of one or more polypeptides associated with a DNA repair or replication pathway. Inhibitors may act directly, e.g., by reducing the activity or expression of a polypeptide required for DNA repair or replication, or indirectly, e.g., by increasing the activity or expression of a polypeptide that blocks DNA repair or replication. In certain embodiments, an inhibitor specifically binds to a target polypeptide or a polynucleotide encoding a target polypeptide.

In certain embodiments, the invention is directed to inhibitors of RecBC(D)-mediated homologous recombination or similar biological pathways in other organisms and cells. Thus, in specific embodiments, an inhibitor reduces one or more biochemical, enzymatic or biological activities of a polypeptide associated with RecBC(D)-mediated homologous recombination, such as, e.g., RecB, RecA, PriA, RuvA, RuvB, RuvC, RecG, RecC, RecD, RecF, UvrD, or Rep helicase, or a variant, homolog, or ortholog thereof.

In one embodiment, an inhibitor reduces the expression or activity of RecBC(D), such nuclease, helicase, or ATPase activity. In another embodiment, an inhibitor reduces one or more activities of RecA, such as ATPase activity. In other embodiments, an inhibitor reduces one or more activities of RuvAB(C) or a subunit thereof. RuvAB(C) is a multisubunit complex with both helicase and branch migration capabilities. In another embodiment, an inhibitor reduces one or more activities of RecG. RecG is a helicase that promotes branch migration of Holliday junctions. In a further embodiment, an inhibitor reduces one or more activities of RecF. RecF binds both DNA and ATP, although no clear enzymatic activity has been defined. Without wishing to be bound to any particular theory, it is believed that RecF may serve to maintain arrested replication forks and assist in loading of RecA, since overexpression of RecA compensated for RecF deficiency. In another embodiment, an inhibitor reduces one or more activities of UvrD helicase.

In additional embodiments, an inhibitor reduces the activity or expression of one or more polypeptides associated with recombination dependent fork repair or replication restart, such as a component of the primosome. Thus, in particular embodiments, an inhibitor reduces the activity or expression of PriA, PriB, PriC, DnaC, or DnaT. Inhibitors of the primosome hypersensitize cells to fluoroquinolones and other antimicrobial and cytotoxic agents based on preventing repair of stalled replication forks. Inhibitors that prevent the formation of a active primosome or inhibit the activity of the primosome also hypersensitive cells to other agents, such as rifampin and its analogs that give rise to blocked replication forks (stalled transcription complexes in the case of rifampin), since they prevent or reduce repair of stalled forks. In one embodiment, an inhibitor reduces one or more activities of PriA. PriA is a key component of the system for priming DNA synthesis in E. coli. PriA is known to possess ATPase, helicase and primase activities.

As described above, RecFOR-mediated HR is an important repair pathway of the damage underlying UV sensitivity and “thymineless death.” Accordingly, inhibitors of this pathway can be used, alone or in combination with DNA damaging agents, e.g., trimethorprim or aminopterin, that impact these pathways, as well as members of the FQ class of drugs that cause damage that is processed by the RecFOR pathway, to reduce viability of drug-resistant microorganisms and cells and enhance sensitivity of both drug-resistant and drug-sensitive cells. Thus, in additional embodiments, an inhibitor of the present invention reduces the activity or expression of one or more polypeptides of the RecFOR pathway, such as, e.g., RecF, RecA, RecO, and RecR. In particular embodiments, the inhibitor reduces activity of the RecFOR pathway in the presence of a mutation in sbcA, sbcB, or sbcC.

In addition, DNA damaged by thymine starvation is a substrate for recombinational repair. Mutations in recBC(D) recombinational repair genes increase sensitivity to thymineless death (Ann. Rev. Microbiol. 52:591-625 (1998)). Thus, inhibitors of recombination enzymes, such as RecBC(D) and RecA are understood, according to the present invention, to hypersensitize bacteria and other microorganisms to thymine starvation or to blockers of thymine metabolism, such as trimethoprim.

The E. coli mazEF suicide cassette is reported to modulate thymineless death (J. Bact. 185:1803-1807 (2003)). This suicide cassette consists of a toxin (MazF and an antitoxin (MazE). Therefore, inhibitors, e.g., small molecules, that tip the balance of this trigger toward an excess of MazF, e.g., by inhibiting MazE expression or activity or enhancing MazF activity or expression, hypersensitize bacteria to killing by these antibiotics. Accordingly, in particular embodiments, an inhibitor of the present invention reduces the activity or expression of MazE.

In related embodiments, inhibitors reduce the expression or activity of a polypeptide associated with DNA repair, recombination, or replication in other microorganisms or eukaryotic cells. For example, in particular embodiments, an inhibitor targets a polypeptide that is a homolog or functionally analogous polypeptide to any of those specifically identified herein, such as the AddAB complex in gram-positive bacteria (e.g., B. anthracis).

Inhibitors, in other embodiments, are targeted to one or more components of a mammalian DNA repair or replication pathway. Such pathways may be HR and non-HR pathways, such as, e.g., NHEJ or NHR. Accordingly, in particular embodiments, an inhibitor reduces the activity or expression of a polypeptide associated with a mammalian DNA repair pathway, such as, e.g., DNA-PK, Ku70, Ku86, or XRCC4.

In certain embodiments, an inhibitor reduces activity or expression of a polypeptide associated with a mammalian DNA repair, recombination, or replication pathway, such as, e.g., a component of the MRX complex (i.e., Mre11, Rad50, and Xrs2), Tel1, replication protein A, Rad59, Rad51, Rad54, Rad55, Rad57, Srs2; or Sgs1. Inhibitors may inhibit the activity or expression of one or more other mammalian polypeptides, such as, e.g., BRCA1 or BRCA2.

Inhibitors may be characterized based upon the type of enzymatic, biochemical, or biological activity that they inhibit. Accordingly, in various embodiments, inhibitors reduce or inhibit an endonuclease, exonuclease, ATP-ase, helicase, DNA binding, or polymerase activity.

In general, inhibitors may be naturally-occurring or non-naturally occurring. In addition, an inhibitor may be isolated or purified. As would be readily understood by one of skill in the art, an inhibitor may be any of a wide variety of different types of molecules, each type having been shown to be capable of possessing polypeptide inhibitory properties in various contexts. For example, in various embodiments, inhibitors comprise a nucleic acid, a polypeptide, a peptide, a peptidomimetic, a peptide nucleic acid (“PNA”), an antibody, a phage, a phagemid, or a small or large organic or inorganic molecule. Inhibitors further include salts, prodrugs, derivatives, homologs, analogs and fragments of any of these classes of molecules.

A wide variety of different types of molecules can be used as inhibitors. The skilled artisan would readily appreciate that polypeptide components associated with DNA repair, recombination, and replication may be inhibited by many different mechanisms. For example, it is generally accepted that antibodies, or fragments thereof, can be generated that bind to a functional region of a polypeptide and inhibit its function. Similarly, it is understood that antisense and RNAi reagents can be produced that effectively prevent expression of a target polypeptide. Accordingly, the skilled artisan would appreciate that inhibitors of the present invention may be broadly defined based upon their inhibitory function, rather than their particular structural characteristics. Indeed, previously identified inhibitors of RecB include the molecule pyridoxal phosphate, as well as the lambda gam polypeptide (i.e., lambda gamma protein and its homologues, phage T7 gene 5.9 and its homologues, P22 phage encoded Abc1 and Abc2 and their homologues for example), thereby demonstrating that very different types of molecules can serve as effective inhibitors of RecB function.

In certain embodiments, inhibitors are polynucleotides capable of inhibiting one or more pathways and/or polypeptides associated with DNA repair, recombination or replication. The polynucleotide compositions of this invention can include genomic sequences, coding sequences, complementary sequences, extra-genomic and plasmid-encoded sequences, linear or circular polynucleotides, and vectors and smaller engineered gene segments that express, or may be adapted to express, proteins, polypeptides, peptides and the like. Such polynucleotides may be naturally isolated, or modified synthetically. Polynucleotides of the invention may be single-stranded (coding or antisense strand) or double-stranded, and may be DNA (genomic, cDNA or synthetic) or RNA molecules. In various embodiment, polynucleotide inhibitors are antisense RNA, ribozymes, or RNA interference reagents designed to specifically inhibit expression of a polypeptide involved in double-stranded DNA break repair or stalled replication fork rescue or repair, such as, e.g., RecB, RecA, PriA, RuvA, RuvB, RecG, RecA, RecC, and RecF. In addition, in particular embodiments, any of the various polynucleotide inhibitors described herein comprise a polynucleotide sequence corresponding to or complementary to a region of a gene encoding a component of a double-stranded DNA break repair or stalled replication fork rescue or repair pathway, including, e.g., RecB, RecA, PriA, RuvA, RuvB, RecG, RecA, RecC, or RecF.

The present invention is further directed to formulations of inhibitors of DNA repair or replication. Formulations are typically adapted for particular uses and include, e.g., pharmaceutical compositions suitable for administration to a patient, i.e., physiologically compatible. Accordingly, compositions of the inhibitors will often further comprise one or more buffers or carriers. In any of the compositions or formulations herein, the inhibitor can be formulated as a salt, a prodrug, or a metabolite.

In addition, compositions of the present invention may comprise a pharmaceutically effective buffer or carrier. As used herein, a “pharmaceutical acceptable carrier” is a pharmaceutically acceptable solvent, suspending agent or vehicle for delivering an inhibitor of the present invention to a microorganism, animal or human. The carrier may be, for example, gaseous, liquid or solid and is selected with the planned manner of administration in mind.

General examples of carriers include buffers (e.g., neutral buffered saline or phosphate buffered saline), carbohydrates (e.g., glucose, mannose, sucrose or dextrans), mannitol, proteins, polypeptides or amino acids such as glycine, antioxidants, bacteriostats, chelating agents such as EDTA or glutathione, adjuvants (e.g., aluminum hydroxide), solutes that render the formulation isotonic, hypotonic or weakly hypertonic with the blood of a recipient, suspending agents, thickening agents and/or preservatives.

Examples of pharmaceutically acceptable carriers for oral pharmaceutical formulations include lactose, sucrose, gelatin, agar and bulk powders. In certain embodiments, pharmaceutical compositions of the present invention are formulated as tablets or capsules for oral administration. Such tablets or capsules may be formulated for specific release characteristics, e.g., extended release capsules. In particular embodiments, wherein a composition of the invention comprises both an inhibitor of DNA repair or replication and another antimicrobial or cytotoxic agent, the composition may be formulated as a mixture or in layers, e.g., the antimicrobial or cytotoxic agent may be encapsulated by the inhibitor or vice versa.

Formulations suitable for parenteral administration include aqueous and non-aqueous formulations isotonic with the blood of the intended recipient; and aqueous and non-aqueous sterile suspensions which may include suspending systems designed to target the compound to blood components or one or more organs. The formulations may be presented in unit-dose or multi-dose sealed containers, for example, ampoules or vials. Extemporaneous injection solutions and suspensions may be prepared from sterile powders, granules and tablets of the kind previously described. Parenteral and intravenous formulation may include minerals and other materials to make them compatible with the type of injection or delivery system chosen.

Commonly used pharmaceutically acceptable carriers for parenteral administration includes, water, a suitable oil, saline, aqueous dextrose (glucose), or related sugar solutions and glycols such as propylene glycol or polyethylene glycols. Solutions for parenteral administration preferably contain a water soluble salt of the active ingredient, suitable stabilizing agents and, if necessary, buffer substances. antioxidizing agents, such as sodium bisulfite, sodium sulfite, or ascorbic acid, either alone or combined, are suitable stabilizing agents. Citric acid salts and sodium EDTA may also be used as carriers. In addition, parenteral solutions may contain preservatives, such as benzalkonium chloride, methyl- or propyl-paraben, or chlorobutanol. Suitable pharmaceutical carriers are described in Remington, cited above.

The present invention additionally contemplates inhibitors formulated for veterinary administration by methods conventional in the art, and also inhibitors formulated for industrial applications with, for example, a cleaning product, such as soap, laundry detergent, shampoo, dishwashing soap, toothpaste, cosmetics, and cleaning detergents.

In certain embodiments, the pharmaceutical compositions are in unit dosage form. In such form, the composition is divided into unit doses containing appropriate quantities of the active component. The unit dosage form can be a packaged preparation, the package containing discrete quantities of the preparations, for example, packeted tablets, capsules, and powders in vials or ampoules. The unit dosage form can also be a capsule, cachet, or tablet, or it can be the appropriate number of any of these packaged forms.

The compositions and pharmaceutical formulation herein can be administered to an organism by any means known in the art. Routes for administering the compositions and pharmaceutical formulations herein to an animal, such as a human, include parenterally, intravenously, intramuscularly, orally, by inhalation, topically, vaginally, rectally, nasally, buccally, transdermally, as eye drops, or by an implanted reservoir external pump or catheter.

Pharmaceutical compositions of the present invention will typically comprise an amount of inhibitor that is sufficient to achieve a therapeutic or prophylactic effect upon administration to a patient at a prescribed dosage. The actual effective amount will depend upon the condition being treated, the route of administration, the drug treatment used to treat the condition, and the medical history of the patient. Determination of the effective amount is well within the capabilities of those skilled in the art. The effective amount for use in humans can be determined from animal models. For example, a dose for humans can be formulated to achieve circulating concentrations that have been found to be effective in animals. The effective amount of an inhibitor can vary if the inhibitor is coformulated with another therapeutic agent (e.g., antimicrobial or cytotoxic agent or compound, such as an antibiotic, an antineoplastic agent, an antiviral agent, an antiprotozoan agent, etc.).

In various embodiments, an inhibitor of the DNA repair, recombination, and replication is co-formulated with an additional therapeutic agent. An inhibitor may be provided to a microorganism, cell or patient before, at the same time as, of after an additional therapeutic agent is provided to the microorganism, cell or patient.

In certain embodiments, a composition of the present invention further comprises or is administered in combination with an antibiotic. Examples of antibiotics that may be coformulated or administered with an inhibitor of DNA repair or replication include aminoglycosides, carbapenems, cephalosporins, cephems, glycopeptides, fluoroquinolones/quinolones, macrolides, oxazolidinones, penicillins, streptogramins, sulfonamides, and tetracyclines.

Specific examples of fluoroquinolones/quinolones include ciproflaxacin, levofloxacin, ofloxacin, cinoxacin, nalidixic acid, gatifloxacin, norfloxacin, lomefloxacin, trovafloxacin, moxifloxacin, sparfloxacin, gemifloxacin, and pazufloxacin. Other quinolones have been recently described, including the nonfluorinated quinolones, PGE 926932 and PGE 9509924 (Jones, M. E. et al., Antimicrob Agents Chemother. 46:1651-7 (2002)) and ciprofloxacin dimers (Gould, K. A., et al., Antimicrob Agents Chemother. 48:2108-15 (2004)). However, certain fluoroquinolones are not widely available due to side effects. For example, sparfloxacin is associated with a high incidence of photosensitivity, grepafloxacin is associated with QTc prolongation, and loefloxacin is associated with a high incidence of photosensitivity.

Other antibiotics contemplated herein (some of which may be redundant with the list above) include abrifam; acrofloxacin; aptecin, amoxicillin plus clavulonic acid; amikacin; apalcillin; apramycin; astromicin; arbekacin; aspoxicillin; azidozillin; azithromycin; aziocillin; aztreonam; bacitracin; benzathine penicillin; benzylpenicillin; clarithromycin, carbencillin; cefaclor; cefadroxil; cefalexin; cefamandole; cefaparin; cefatrizine; cefazolin; cefbuperazone; cefcapene; cefdinir; cefditoren; cefepime; cefetamet; cefixime; cefinetazole; cefminox; cefoperazone; ceforanide; cefotaxime; cefotetan; cefotiam; cefoxitin; cefpimizole; cefpiramide; cefpodoxime; cefprozil; cefradine; cefroxadine; cefsulodin; ceftazidime; ceftriaxone; cefuroxime; cephalexin; chloramphenicol; chlortetracycline; ciclacillin; cinoxacin; ciprofloxacinfloxacin; clarithromycin; clemizole penicillin; cleocin, cleocin-T, clindamycin; cloxacillin; corifam; daptomycin; daptomycin; demeclocycline; desquinolone; dibekacin; dicloxacillin; dirithromycin; doxycycline; enoxacin; epicillin; erthromycin; ethambutol; gemifloxacin; fenampicin; finamicina; fleroxacin; flomoxef; flucloxacillin; flumequine; flurithromycin; fosfomycin; fosmidomycin; fusidic acid; gatifloxacin; gemifloxaxin; gentamicin; imipenem; imipenem plus cilistatin combination; isepamicin; isoniazid; josamycin; kanamycin; kasugamycin; kitasamycin; kairifam, latamoxef; levofloacin, levofloxacin; lincomycin; linezolid; lomefloxacin; loracarbaf; lymecycline; mecillinam; meropenem; methacycline; methicillin; metronidazole; mezlocillin; midecamycin; minocycline; miokamycin; moxifloxacin; nafcillin; nafcillin; nalidixic acid; neomycin; netilmicin; norfloxacin; novobiocin; oflaxacin; oleandomycin; oxacillin; oxolinic acid; oxytetracycline; paromycin; pazufloxacin; pefloxacin; penicillin g; penicillin v; phenethicillin; phenoxymethyl penicillin; pipemidic acid; piperacillin; piperacillin and tazobactam combination; piromidic acid; procaine penicillin; propicillin; pyrimethamine; rifadin; rifabutin; rifamide; rifampin; rifamycin sv; rifapentene; rifomycin; rimactane, rofact; rokitamycin; rolitetracycline; roxithromycin; rufloxacin; sitafloxacin; sparfloxacin; spectinomycin; spiramycin; sulfadiazine; sulfadoxine; sulfamethoxazole; sisomicin; streptomycin; sulfamethoxazole; sulfisoxazole; quinupristan-dalfopristan; teicoplanin; telithromycin; temocillin; gatifloxacin; tetracycline; tetroxoprim; telithromycin; thiamphenicol; ticarcillin; tigecycline; tobramycin; tosufloxacin; trimethoprim; trimetrexate; trovafloxacin; vancomycin; verdamicin; azithromycin; and linezolid.

In certain embodiments, an inhibitor of the present invention is used to treat a microorganism or cell resistant to or in combination with a drug that asserts its effect by causing DNA damage or inhibiting DNA replication or repair. Similarly, an inhibitor of the present invention is also used to sensitize cells to a drug that asserts its effect by causing DNA damage or inhibiting DNA replication or repair. A variety of antimicrobial and chemotherapeutic agents are known to involve such mechanisms. For example, sulphonamides interfere with the use of folic acid and inhibit bacterial replication. Also, as described herein, fluoroquinolones inhibit DNA replication by targeting DNA gyrase and topoisomerase IV. In addition, certain DNA damaging agents, e.g., trimethorprim and aminopterin, cause DNA damage associated with DNA sensitivity or “thymineless death.”

As described herein, in certain methods of the present invention, an inhibitor of a polypeptide associated with DNA repair or replication or fork repair is used to treat a drug-resistant microorganism or cell. A variety of drug-resistant microorganisms have been identified and are known in the art. For example, methicillin-resistant Staphylococcus aureus, vancomycin-resistant Enterococci, and fluoroquinolone-resistant Pseudomonas aeruginosa pose significant resistance problems. Resistance to fluoroquinolones has been reported in a variety of microorganisms, including methicillin-susceptible Staphylococcus aureus, Campylobacter jejuni/coli, Salmonella, Shigella, and E. coli. Resistance emerged first in species in which single mutations were sufficient to cause clinically important levels of resistance, e.g., Staphylococcus aureus and Pseudomonas aeruginosa (Emerg Infect Dis. 7:337-41 (2001)). Subsequently, resistance has emerged in bacteria such as Campylobacter jejuni, E. coli, and Neisseria gonorrhoeae, in which multiple mutations are generally observed in clinically important resistance.

A non-exhaustive list of examples of known drug resistance includes: ciprofloxacin resistant S. aureus, coagulase-negative Staph, E. faecalis, E. faecium, E. coli, K. oxytoca, K. pneumoniae, M. morganii, P. mirabilis, S. marcescens, Acinetobacter, and P. aeruginosa; levofloxacin resistant S. pneumoniae, S. pyogenes, S. agalactiae, Viridans group, E. coli, K. oxytoca, K. pneumoniae, M. morganii, P. mirabilis, S. marcenscens, Acinetobacter, and P. aeruginosa; sulfamethoxazole trimethoprim resistant E. coli, K. oxytoca, K. pneumoniae, M. Morganii, P. mirabilis, S. marcenscens, Acinetobacter, and P. aeruginosa; ampicillin resistant S. aureus, coagulase-negative staph, E. faecalis, E. faecium, and S. pneumoniae; oxacillin resistant S. aureus and coagulase-negative staph; penicillin resistant S. pneumoniae and Virdans group; piperacillin-tazobactam resistant E. coli, K. oxytoca, K. pneumoniae, M. morganii, P. mirabilis, S. marcescens, Acinetobacter, and P. aeruginosa; cefapine resistant S. aureus, coagulase-negative staph, S. pneumoniae, E. coli, K. oxytoca, K. pneumoniae, M. morganii, P. mirabilis, S. marcescens, Acinobacter, and P. aeruginosa; cefotaxime resistant S. aureus, coagulase-negative staph, S. pneumoniae, E. coli, K. oxytoca, K. pneumoniae, M. morganii, P. mirabilis, S. marcenscens, Acinetobacter, and P. aeruginosa; ceftriaxone resistant S. aureus, coagulase-negative staph, S. pneumoniae, M. morganii, P. mirabilis, S. marcescens, Acinetobacter, and P. aeruginosa; gentamycin resistant S. aureus, coagulase-negative staph, E. faecalis, E. faecium, E. coli, K. oxytoca, K. pneumoniae, M. morganii, P. mirabilis, S. marcenscens, Acinobacter, and P. aeruginosa; clarithromycin resistant S. pneumoniae, S. pyogenes, S. agalactiae, and Virdans group; erythromycin resistant S. pneumoniae, S. pyogenes, and S. agalactiae, and Virdans group; teicoplanin resistant E. faecium; vancomycin resistant E. faecalis and E. faecium; and imipenem resistant Acinobacter and P. aeruginosa.

In certain embodiments, a composition of the present invention further comprises or is administered in combination with an antifungal. A variety of different classes of antifungal agents exist. Example of antifungals include, but are not limited to, allymines and other non-azole ergosterol biosynthesis inhibitors, antimetabolites, azoles, glucan synthesis inhibitors, polyenes, and other miscellaneous systemic antifungals.

In certain embodiments, a composition of the present invention further comprises or is administered in combination with an antiviral agent. Examples of antiviral agents include, but are not limited to idoxuridine (IDU), which is used in topical therapy of herpes simplex keratoconjunctivitis; vidarabine (adenine arabinoside, ara-A), which is used, e.g., in the treatment of HSV infections; trifluridine (trifluorothymidine), a thymidine analog, which interferes with DNA synthesis and is effective in treating primary keratoconjunctivitis and recurrent keratitis caused by HSV-1 and HSV-2; acyclovir, which is a purine nucleoside analog with activity against herpes and cytomegalovirus (CMV); famciclovir, which is a pro-drug of the active antiviral penciclovir and is used to treat HSV-1, HSV-2, VZV, EBV, CMV, and HBV; penciclovir, a guanosine analog that inhibits HSV-1 and HSV-2 viral DNA polymerase; valacyclovir; ganciclovir which is used against all herpes viruses, including CMV, as well as HIV and CMV retinitis; foscarnet, an organic analog of inorganic pyrophosphate that inhibits virus-specific DNA polymerase and reverse transcriptase; ribavirin, a guanosine analog that inhibits the replication of many RNA and DNA viruses; amantadine and rimantadine, which are used primarily for influenza A prophylaxis and treatment, interfere with the development of immunity from the vaccine; cidofovir (cytosine; HPMPC), which is a nucleotide analog that has inhibitory in vitro activity against a broad spectrum of viruses, including HSV-1, HSV-2, VZV, CMV, EBV, adenovirus, human papillomavirus (HPV), and human polyomavirus, as well as oligonucleotides, immune globulins, such as hyperimmune CMV immunoglobulin and interferons.

In certain embodiments, a composition of the present invention further comprises or is administered in combination with an antineoplastic agent or chemotherapeutic compound. In particular embodiments, the antineoplastic agent is a DNA damaging agent, an agent that inhibits DNA replication, or a topoisomerase poison. Antracyclines, amsacrine and ellipticines are examples of intercalating agents that act as topoisomerase II poisons. Camptothecin and VM26 (teniposide) are representative DNA topoisomerase poisons that target DNA topoisomerase I and topoisomerase II, respectively. Camptothecin (CPT) compounds include various 20(S)-camptothecins, analogs of 20(S)camptothecin, and derivatives of 20(S)-camptothecin. Camptothecin, when used in the context of this invention, includes the plant alkaloid 20(S)-camptothecin, both substituted and unsubstituted camptothecins, and analogs thereof. Examples of camptothecin derivatives include, but are not limited to, 9-nitro-20(S)-camptothecin, 9-amino-20(S)-camptothecin, 9-methyl-camptothecin, 9-chlorocamptothecin, 9-flourocamptothecin, 7-ethyl camptothecin, 10-methylcamptothecin, 10-chloro-camptothecin, 10-bromo-camptothecin, 10-fluoro-camptothecin, 9-methoxy-camptothecin, 11-fluoro-camptothecin, 7-ethyl-10-hydroxy camptothecin, 10,11-methylenedioxy camptothecin, and 10,11-ethylenedioxy camptothecin, and 7-(4-methylpiperazinomethylene)-10,11-methylenedioxy camptothecin. Prodrugs of camptothecin include, but are not limited to, esterified camptothecin derivatives as described in U.S. Pat. No. 5,731,316, such as camptothecin 20-O-propionate, camptothecin 20-O-butyrate, camptothecin 20-O-valerate, camptothecin 20-O-heptanoate, camptothecin 20-O-nonanoate, camptothecin 20-O-crotonate, camptothecin 20-O-2′,3′-epoxy-butyrate, nitrocamptothecin 20-O-acetate, nitrocamptothecin 20-O-propionate, and nitrocamptothecin 20-O-butyrate. Particular examples of 20(S)-camptothecins include 9-nitrocamptothecin, 9-aminocamptothecin, 10,11-methylendioxy-20(S)camptothecin, topotecan, irinotecan, 7-ethyl-10-hydroxy camptothecin, or another substituted camptothecin that is substituted at least one of the 7, 9, 10, 11, or 12 positions. These camptothecins may optionally be substituted.

Other examples of antineoplastic agents that may be coformulated or administered with an inhibitor of the present invention include: acivicin; aclarubicin; acodazole hydrochloride; acronine; adozelesin; aldesleukin; altretamine; ambomycin; ametantrone acetate; aminoglutethimide; amsacrine; anastrozole; anthramycin; asparaginase; asperlin; azacitidine; azetepa; azotomycin; batimastat; benzodepa; bicalutamide; bisantrene hydrochloride; bisnafide dimesylate; bizelesin; bleomycin sulfate; brequinar sodium; bropirimine; busulfan; cactinomycin; calusterone; caracemide; carbetimer; carboplatin; carmustine; carubicin hydrochloride; carzelesin; cedefingol; chlorambucil; cirolemycin; cisplatin; cladribine; crisnatol mesylate; cyclophosphamide ; cytarabine; dacarbazine; dactinomycin; daunorubicin hydrochloride; decitabine; dexormaplatin; dezaguanine; dezaguanine mesylate; diaziquone; docetaxel; doxorubicin; doxorubicin hydrochloride; droloxifene; droloxifene citrate; dromostanolone propionate; duazomycin; edatrexate; eflornithine; hydrochloride; elsamitrucin; enloplatin; enpromate; epipropidine; epirubicin hydrochloride; erbulozole; esorubicin hydrochloride; estramustine; estramustine phosphate sodium; etanidazole; ethiodized oil; etoposide; etoposide phosphate; etoprine; fadrozole hydrochloride; fazarabine; fenretinide; floxuridine; fludarabine phosphate; fluorouracil; flurocitabine; fosquidone; fostriecin sodium; gemcitabine; gemcitabine hydrochloride; hydroxyurea; idarubicin hydrochloride; ifosfamide; imofosine; interferon alpha-2a; interferon alpha-2b; interferon alpha-n1; interferon alpha-n3; interferon beta-la; interferon gamma-lb; iproplatin; irinotecan hydrochloride; lanreotide acetate; letrozole; leuprolide acetate liarozole hydrochloride; lometrexol sodium; lomustine; losoxantrone hydrochloride; masoprocol; maytansine; mechlorethamine hydrochloride; megestrol acetate; melengestrol acetate; melphalan; menogaril; mercaptopurine; methotrexate; methotrexate sodium; metoprine; meturedepa; mitindomide; mitocarcin; mitocromin; mitogillin; mitomalcin; mitomycin; mitosper; mitotane; mitoxantrone hydrochloride; mycophenolic acid; nocodazole; nogalamycin; ormaplatin; oxisuran; paclitaxel; pegaspargase; peliomycin; pentamustine; peplomycin sulfate; perfosfamide; pipobroman; piposulfan; piroxantrone hydrochloride; plicamycin; plomestane; porfimer sodium; porfiromycin; prednimustine; procarbazine hydrochloride; puromycin; puromycin hydrochloride; pyrazofurin; riboprine; rogletimide; safingol; safingol hydrochloride; semustine; simtrazene; sparfosate sodium; sparsomycinl; spirogermanium hydrochloride; spiromustine; spiroplatin; streptonigrin; streptozocin; strontium chloride sr 89; sulofenur; talisomycin; taxane; taxoid; tecogalan sodium; tegafur; teloxantrone hydrochloride; temoporfin; teniposide; teroxirone; testolactone; thiamiprine; thioguanine; thiotepa; tiazofurin; tirapazamine; topotecan hydrochloride; toremifene citrate; trestolone acetate; triciribine phosphate; trimetrexate; trimetrexate glucuronate; triptorelin; tubulozole hydrochloride; uracil mustard; uredepa; vapreotide; verteporfin; vinblastine sulfate; vincristine sulfate; vindesine; vindesine sulfate; vinepidine sulfate; vinglycinate sulfate; vinleurosine sulfate; vinorelbine tartrate; vinrosidine sulfate; vinzolidine sulfate; vorozole; zeniplatin; zinostatin; and zorubicin hydrochloride. Additional antineoplastic agents that are disclosed herein or known in the art are also contemplated by the present invention.

The present invention also includes kits comprising one or more inhibitors of DNA repair or replication. Kits may further comprise one or more additional therapeutic compounds (antimicrobial or cytotoxic agent or compound, e.g., an antimicrobial agent, such as an antibiotic, antifungal, or antiviral, antiprotozoan, or a cytotoxic agent, e.g., a chemotherapeutic agent).

Typically, kits of the present invention comprise one or more vials or containers, with one of said vials comprising an inhibitor of the present invention, as well as instructions for the use of the kit. For example, instructions can direct an individual as to the specific inhibitor to be used, dosages to be applied, frequency and duration of use, and methods of administration. Preferably, a vial comprises an inhibitor in a pharmaceutical formulation. In some embodiments, a kit comprises one or more vials of an inhibitor formulated for local or system administration. In certain embodiments, an additional vial comprises another therapeutic agent (e.g., an antibiotic, an antiviral, an antifungal, an antineoplastic, or an antiprotozoan medication). The inhibitor and the second therapeutic agent can be combined prior to administration or may be administered separately.

Methods of Identifying Inhibitors

Methods of identifying inhibitors of DNA repair, recombination or replication include both function-based screens and binding-based screens. Such screens may be performed using whole cells or purified polypeptides. In one embodiment, an inhibitor is identified based upon its ability to bind to or inhibit an activity of a polypeptide involved in DNA repair, recombination or replication, including any polypeptide described herein.

Methods of identifying molecules that bind to a polypeptide are widely available and known in the art. The skilled artisan would be fully apprised as to methods of screening or testing molecules to determine their ability to specifically bind a particular polypeptide, based upon general knowledge available in the art, in light of the particular type of molecule being screened.

In one embodiment, the invention provides a general method of identifying an agent that increases the microbicidal activity of an antimicrobial compound (or the antineoplastic activity of a chemotherapeutic agent), comprising:

(a) screening one or more candidate agents for their ability to bind a polypeptide associated with DNA repair, recombination or replication; and (b) identifying one or more agents that bind to said polypeptide.

In another embodiment, the invention provides a general method of identifying an agent that is microbicidal or cytotoxic for a drug-resistant microorganism or cell, comprising: (a) screening one or more candidate agents for their ability to bind a polypeptide associated with DNA repair, recombination, or replication; and (b) identifying one or more agents that bind to said polypeptide.

In one embodiment, inhibitors are identified by screening libraries of molecules or chemical compounds, e.g., small molecules. Such libraries and methods of screening the same are known in the art and include: biological libraries, natural products libraries, spatially addressable parallel solid phase or solution phase libraries, synthetic library methods requiring deconvolution, the ‘one-bead one-compound’ library method, and synthetic library methods using affinity chromatography selection. The biological library approach is largely limited to polypeptide libraries, while the other four approaches are applicable to polypeptide, non-peptide oligomer or small molecule libraries of compounds. See Lam, K. S. (1997) Anticancer Drug Des. 12:145. In certain embodiments, screening of libraries is performed using an array or microarray, which permits the testing of multiple compounds, e.g., small molecules, polypeptides, or antibodies) simultaneously. In particular embodiments, screening is high throughput screening.

In one embodiment, inhibitors are identified using Automated Ligand Identification System (referred to herein as “ALIS”). See, e.g., U.S. Pat. Nos. 6,721,665, 6,714,875, 6,694,267, 6,691,046, 6,581,013, 6,207,861, and 6,147,344. ALIS is a high-throughput technique for the identification of small molecules that bind to proteins of interest (e.g., RecB, PriA, or RecA). Small molecules found to bind tightly to a protein can then be tested for their ability to inhibit the biochemical activity of that protein.

Thus, in some embodiments, a target protein (e.g., RecB, RecA, or PriA) is mixed with pools of small molecules. Preferably, more than 1,000 pools are used, more preferably more than 2,000 pools are used, more preferably more than 3,000 pools are used, or more preferably, more than 10,000 pools are used. Each pool contains approximately, 1,000 compounds, more preferably approximately 2,500 compounds, or more preferably approximately 5,000 compounds that are ‘mass encoded,’ meaning that their precise molecular structure can be determined using only their mass and knowledge of the chemical library.

The small molecules and proteins are mixed together and allowed to come to equilibrium (they are incubated together for 30 minutes at room temperature). The mixture is rapidly cooled to trap bound complexes and subject to rapid size exclusion chromatography (SEC). Small molecules that bind tightly to the protein of interest will be co-excluded with the protein during SEC. Mass spectroscopic analysis is performed to determine the masses of all small molecules found to bind the protein. Measurement of these masses allows for the rapid determination of the molecular structures of the small molecules.

In certain embodiments, such screening methods further comprise testing agents identified based upon their ability to bind a component of a DNA repair or replication pathway for their ability to increase the microbicidal activity of an antimicrobial compound or increase the cytotoxic activity of a chemotherapeutic compound. In other embodiments, such screening methods further comprise testing agents identified based upon their ability to bind a component of a DNA repair or replication pathway for microbicidal or cytotoxic activity against drug-resistant microorganisms or cells.

In a further embodiment, a peptide or polypeptide that binds a polypeptide component of a DNA repair or replication pathway is identified using phage display or related methods.

In other related embodiments, inhibitors of DNA repair or replication are identified based upon their ability to interfere with one or more enzymatic or biological activities of a polypeptide associated with DNA repair or replication. In various embodiments, such polypeptides include one or more of RecBC(D)'s helicase, ATPase, or nuclease activities, or PriA or RuvAB's helicase activity. A variety of in vitro and in vivo assays are known and available for measuring helicase, ATPase, and nuclease activities and any may be used according to the invention. In certain embodiments, such assays are performed using recombinantly-produced polypeptides involved in DNA repair or replication, e.g., RecBC(D)-mediated homologous recombination. Such polypeptides may be used individually, e.g., RecB, RecA, or PriA, or in combination, e.g., RecBC(D).

In certain embodiments, functional assays to identify inhibitors of DNA repair or replication include whole cell assays. For example, in one embodiment, whole cell screens are performed to identify inhibitors of DNA repair or replication that sensitive cells to an antimicrobial or chemotherapeutic agent, such as drugs that target topoisomerases, e.g., topoisomerase poisons. In addition, in certain embodiments, methods of identifying inhibitors of DNA repair or replication comprise screening potential inhibitors, or libraries thereof, to identify inhibitors that sensitize both wild-type E. coli and E. coli comprising one or both of S83L and parc mutations to an antibiotic.

Whole cell assays of the present invention are not limited to those designed to identify an inhibitor that targets a particular pathway or polypeptide associated with DNA repair or replication. Rather, in certain embodiments, whole cell assays of the present invention are used to identify an inhibitor, based directly upon its ability to enhance sensitivity of a microorganism or cell to an antimicrobial or cytotoxic agent. The ability of an identified inhibitor to inhibit an activity or expression of a polypeptide associated with DNA repair or replication may be confirmed in a separate assay.

For example, in particular embodiments, inhibitors that hypersensitize mammalian cells to topoisomerase poisons are identified by standard HTS screening of libraries of small molecules. Targets of these agents are identified by standard chemical genomics methods. Identified targets are subjected to standard SAR and optimization schemas. In particular embodiments, such screens are performed using cells with mutations in their topoisomerases (essentially the equivalent of a synthetic lethal screen on gyrA). In other embodiments, such screens are used to identify inhibitors that hypersensitize cells with mutant topoisomerases to the original topoisomerase poisons.

In one particular embodiment of whole cell screens to identify a compound that enhances the sensitivity of a microorganism or cell to an antimicrobial or cytotoxic agent, the method involves contacting a microorganism or cell with a candidate compound in the presence of an antimicrobial or cytotoxic agent, and then determining whether said microorganism or cell has increased sensitivity to the antimicrobial or cytotoxic agent as compared to a microorganism or cell that is not treated with the candidate compound. Increased sensitivity indicates that the candidate compound enhances the sensitivity of the microorganism or cell to the antimicrobial or cytotoxic agent.

These methods may be conducted using any microorganism or cell, as well as any antimicrobial or cytotoxic agent, including those described herein. In particular embodiments, the method is conducted using a fluoroquinolone, e.g., ciprofloxacin. In particular embodiments, the method is conducted using a microorganism or cell contains a mutation in a gene encoding a polypeptide associated with DNA repair or replication, such as, e.g., a mutation in S83 or D87 of gyrA or S80 of parc.

In another particular embodiment of whole cell screens, the invention includes a method of identifying a compound that inhibits induction of the SOS response pathway, mutagenesis, or the development of drug resistance, induced by an antimicrobial or cytotoxic agent, wherein said method includes contacting a microorganism or cell with a candidate compound in the presence of a sublethal dose of an antimicrobial or cytotoxic agent, wherein said microorganism comprises an SOS pathway-inducible reporter gene, and determining whether expression of the reporter polypeptide is reduced in the microorganism or cell contacted with the candidate compound as compared to a microorganism or cell comprising said polynucleotide that is not treated with the candidate compound. Reduced expression of the reporter gene indicates that the compound enhances the sensitivity of the microorganism of cell to the antimicrobial or cytotoxic agent.

A reporter gene construct generally comprises a polynucleotide containing an inducible promoter and encoding a reporter polypeptide. A variety of reporter polypeptides are known and available in the art, including, e.g., luciferase. In one embodiment of this aspect of the present invention, the SOS pathway inducible promoter sequence includes a portion of a promoter or enhancer sequence of a gene known to be induced in response to SOS pathway activation, such as, e.g., an error-prone polymerase gene.

Whole cell screening assays may be performed using a library of candidate compounds and can be performed using high throuput methods, such as the utilization of microtitre plates comprising multiple wells that can be assayed simultaneously, e.g., using a fluorescence plate reader device.

In certain embodiments, inhibitors of RecBC(D) are identified based upon their ability to interfere with or reduce RecBC(D) helicase or hydrolysis activities. In particular embodiments, RecBC(D) exonuclease or endonuclease activity is examined. The dual enzymatic activities (i.e., ATP hydrolysis and DNA unwinding) of RecBC(D) provide two different assays in which to characterize its activity in vitro. ATP hydrolyzing enzymes generate Pᵢ, ADP, and H⁺. Techniques have been developed to monitor the formation of each of these species. For example, one technique utilizes the enzyme pyruvate kinase to convert ADP back into ATP, generating pyruvate from phosphoenolpyruvate in the process. A second enzyme, L-lactate dehydrogenase uses NADH to convert pyruvate to lactate, and the resulting decrease in absorbance at 340 nm is readily monitored with a standard plate reader (Kiinitsa, K. et al., Anal. Biochem. 321:266-271 (2003).

A more direct means of observing helicase activity is to utilize a DNA substrate that is labeled on complementary strands with a fluorophore-quencher pair. Unwinding of the DNA by RecBC(D) is accompanied by a marked increase in fluorescence as the distance between the two probes increases (Lucius, A. L., et al., J. Mol. Biol. 339:731-750 (2004).

E. coli strains bearing the temperature sensitive mutation parE10(Ts) are dependent on PriA for viability at the non-permissive temperature where topoisomerase IV is inactive (Michel et al, J. Bact. 186:1197-1199, 2004). Thus, inhibitors of PriA (or other steps in the repair pathway) may be identified by screening for molecules that kill this strain at the non-permissive temperature.

Salmonella typhimurium strains bearing the temperature sensitive gyrA208 or gyrB652 mutations are dependent on RecBC(D) function for viability (Bossi et al., Mol. Microb. 21:111-122, 1996). These are believed to mimic the phenotype of gyrA FQ resistance mutations. Accordingly, in certain embodiments, inhibitors are identified by screening at the non-permissive temperature for small molecules that are lethal to this strain.

Inhibitors may be identified by screening E. coli bearing the gyrAS83L or other mutations in the FQ binding site of GyrA for molecules that inhibit cell growth or sensitize the cells to antibiotic treatment, e.g., treatment with fluoroquinolone.

In other embodiments, inhibitors of DNA repair or replication, e.g., RecBC(D)-mediated homologous recombination (and other homologous and non-homologous recombination pathways), are identified by structural analysis, using molecular modeling software tools, which create realistic 3-D models of molecules structures. Such methods include the use of, e.g., molecular graphics (i.e., 3D representations) and computational chemistry (e.g., calculations of the physical and chemical properties).

Using molecular modeling, rational drug design programs can predict which of a collection of different drug like compounds may fit into the active site of an enzyme, and by computationally adjusting their bound conformation, decide which compounds actually might fit the active site well. See William Bains, Biotechnology from A to Z, 2nd edition, Oxford University Press, 1998, at 259.

Basic information on molecular modeling is known and available in the art: e.g., M. Schlecht, Molecular Modeling on the PC, 1998; John Wiley & Sons; Gans et al., Fundamental Principals of Molecular Modeling, 1996, Plenum Pub. Corp.; N. C. Cohen (editor), Guidebook on Molecular Modeling in Drug Design, 1996, Academic Press; and W. B. Smith, Introduction to Theoretical Organic Chemistry and Molecular Modeling, 1996. U.S. patents that provide detailed information on molecular modeling include U.S. Pat. Nos. 6,093,573; 6,080,576; 5,612,894; 5,583,973; 5,030,103; 4,906,122; and 4,812,12.

For example, in one embodiments, the 3-dimensional structure of RecBC(D) (Singelton, M. R. et al., Nature 432:187-93 (2004)) is used according to methods well known in the art to enable the selection of candidate binders from a virtual library of compounds using methods of molecular modeling and docking. In particular embodiments, candidate binders are selected to bind a particular region of RecBC(D), such as, e.g., a chi cutting site, a region that forms “tunnels,” or a region required for nuclease activity, e.g., exonuclease or endonuclease.

The present invention permits the use of molecular and computer modeling techniques to design and select compounds (e.g., inhibitors) that bind to a polypeptide associated with DNA repair or replication and for which a molecular structure has been determined or can be predicted.

This invention also enables the design of compounds that act as non-competitive inhibitors of DNA repair or replication. These inhibitors may bind to, all or a portion of, an active site of, e.g., RecA or RecB. Similarly, non-competitive inhibitors that bind to either RecA or RecB and inhibit RecA or RecB (whether or not bound to another chemical entity) may be designed using the atomic coordinates of RecA or RecB.

As noted, the crystal structure of RecBC(D) bound to a DNA substrate has been determined (Singleton, M. R. et al., Nature 432:187-93 (2004). In addition, the crystal structure of RecA polypeptides has also been determined (Xing, X. and Bell, C. E. J., J. Mol. Biol. 342:1471-85 (2004)). These structures provide insight regarding important functional domains that might be targeted to interfere with their function, and provide the basis for molecular modeling of inhibitors.

In further embodiments, the present invention enables computational screening of small molecule databases for chemical entities, agents, or compounds that can bind in whole, or in part, to a polypeptide involved in DNA repair or replication, e.g., RecB, PriA, or RecA, and, thereby prevent homologous recombination, non-homologous recombination, or repair of stalled replication forks. In this screening technique, the quality of fit of such entities or compounds to the binding site may be judged either by shape complementarity or by estimated interaction energy. See Meng, E. C. et al., J. Coma. Chem., 13: 505-524 (1992).

The design of compounds that bind to or inhibit one or more activities of a polypeptide involved in DNA repair or replication, e.g., RecB, PriA, or RecA, according to this invention generally involves consideration of two factors. First, the compound must be capable of physically associating with the target polypeptide. Non-covalent molecular interactions important in the association of compounds with target polypeptides include hydrogen bonding, van der Waals and hydrophobic interactions. Second, the compound must be able to assume a conformation that allows it to associate with a target polypeptide. Although certain portions of the compound will not directly participate in this association with a target polypeptide, those portions may still influence the overall conformation of the molecule. This, in turn, may have a significant impact on potency. Such conformational requirements include the overall three-dimensional structure and orientation of the chemical entity or compound in relation to all or a portion of the active site of a target polypeptide or the spacing between functional groups of a compound comprising several chemical entities that directly interact with a target polypeptide.

The potential inhibitory or binding effect of a chemical compound on DNA repair or replication may be analyzed prior to its actual synthesis and by the use of computer modeling techniques. If the theoretical structure of the given compound precludes any potential association between it and a target polypeptide, synthesis and testing of the compound is obviated. However, if computer modeling suggests a strong interaction is possible, the molecule may then be synthesized and tested for its ability to bind a target polypeptide and inhibit an activity associated with DNA repair or replication, such as, e.g., homologous recombination or fork repair. In this manner, synthesis of inactive compounds may be avoided.

One skilled in the art may use one of several methods to screen chemical entities fragments, compounds, or agents for their ability to associate with a target polypeptide. This process may begin by visual inspection of, for example, the active site of a target polypeptide identified based upon actual or predicted structural information. Selected chemical entities, compounds, or agents may then be positioned in a variety of orientations, or docked, within an individual binding pocket of a target polypeptide. Docking may be accomplished using software such as Quanta and Sybyl, followed by energy minimization and molecular dynamics with standard molecular mechanics force fields, such as CHARMM or AMBER.

Specialized computer programs also assist in the process of selecting chemical entities. These include but are not limited to GRID (Goodford, P. J., J. Med. Chem. 28:849-857 (1985)). GRID is available from Oxford University, Oxford, UK; MCSS (Miranker, A. et al., Structure, Function and Genetics, (1991) Vol. 11, 29-34), MCSS is available from Molecular Simulations, Burlington, Mass., AUTODOCK (Goodsell, D. S. and A. J. Olsen, “Automated Docking of Substrates to Proteins by Simulated Annealing” Proteins: Structure. Function, and Genetics, 8, 195-202 (1990)). AUTODOCK is available from Scripps Research Institute, La Jolla, Calif.; DOCK (Kuntz, I. D. et al., J. Mol. Biol., 161:269-288 (1982)). DOCK is available from University of California, San Francisco, Calif.

Once suitable chemical entities, compounds, or agents have been selected, they can be assembled into a single compound or inhibitor. Assembly may proceed by visual inspection of the relationship of the fragments to each other on the three-dimensional image displayed on a computer screen in relation to the atomic coordinates of a target polypeptide. This is followed by manual model building using software such as Quanta or Sybyl.

Useful programs to aid one of skill in the art in connecting the individual chemical entities, compounds, or agents include but are not limited to CAVEAT (Bartlett, P. A. et al, “CAVEAT: A Program to Facilitate the Structure-Derived Design of Biologically Active Molecules”. In Molecular Recognition in Chemical and Biological Problems”, Special Pub., Royal Chem. Soc., 78:82-196 (1989)). CAVEAT is available from the University of California, Berkeley, Calif.; 3D Database systems such as MACCS-3D (MDL Information Systems, San Leandro, Calif.). This area is reviewed in Martin, Y. C., J. Med. Chem. 35:2145-2154 (1992); also HOOK (available from Molecular Simulations, Burlington, Mass.).

Instead of designing an inhibitor in a step-wise fashion, one chemical moiety at a time, as described above, inhibitors may be designed as a whole or “de novo” using either an empty binding site or optionally including some portion(s) of known inhibitor(s). These methods include LUDI (Bohm, H.-J., J. ComR. Aid. Molec. Design 6:61-78 (1992)). LUDI is available from Biosym Technologies, San Diego, Calif. and LEGEND (Nishibata, Y. and A. Itai, Tetrahedron 47:8985 (1991)). LEGEND is available from Molecular Simulations, Burlington, Mass. LeapFrog is available from Tripos Associates, St. Louis, Mo.

Other molecular modeling techniques may also be employed in accordance with this invention. See, e.g., Cohen, N. C. et al., J. Med. Chem. 33:883-894 (1990). See also, Navia, M. A. and M. A. Murcko, Current Opinions in Structural Biology 2:202-210 (1992).

Once a compound has been designed or selected by the above methods, the efficiency with which that compound may bind to a component of a DNA repair or replication pathway and inhibit its activity may be tested and optimized by computational evaluation. An effective inhibitor of DNA repair or replication preferably demonstrate a relatively small difference in energy between its bound and free states (i.e., a small deformation energy of binding). Thus, the most efficient inhibitors should preferably be designed with deformation energy of binding of not greater than about 10 kcal/mole, or more preferably, not greater than 7 kcal/mole.

Once an inhibitor has been optimally selected or designed, as described above, substitutions may then be made in some of its atoms or side groups to improve or modify its binding properties. Generally, initial substitutions are conservative, e.g., the replacement group will have approximately the same size, shape, hydrophobicity and charge as the original group. It should, of course, be understood that components known in the art to alter conformation should be avoided. Such substituted chemical compounds may then be analyzed for efficiency of fit into the 3-D structures of a target polypeptide by the same computer methods described in detail, above.

Methods of Use

In certain embodiments, the methods of the present invention are related to the development and sales of inhibitors of DNA repair, recombination, or replication for a variety of purposes related to killing drug-resistant microorganisms and cells or increasing the sensitivity of microorganisms and cells to antimicrobial and chemotherapeutic agents, including, but not limited to, any disclosed herein.

In one embodiment, an inhibitor is used to sensitize a microorganism or cell to an antimicrobial or chemotherapeutic agent. This involves contacting a microorganism or cell with an inhibitor of DNA repair or replication. In a related embodiment, increasing the microbicidal or cytotoxic activity of an antimicrobial or cytotoxic agent includes contacting a microorganism or cell with an inhibitor of DNA repair or replication in combination with an antimicrobial or cytotoxic agent.

As described throughout, in certain applications of the present invention, inhibitors are intended for administered to a subject or contacted with a microorganism or cell in combination with an antimicrobial or cytotoxic agent. This may occur at the same time, or the inhibitor may be administered or contacted before or after administration or contact with the agent.

Since the methods of the present invention may be used to sensitize a microorganism or cell to a drug, in related embodiments, the present invention includes methods of reducing the minimum inhibitory concentration (MIC) of a drug and methods of shifting the therapeutic index of a drug, such that a lower dosage may be used, when the drug is provided in combination with an inhibitor of DNA repair or replication.

Generally, an increase in the microbicidal or cytotoxic activity of an agent, i.e., drug, is determined using methods routinely available in the art, including, e.g., determining the MIC of the agent in the presence or absence of the inhibitor of DNA repair or replication. In various embodiments, an inhibitor increases the microbicidal or cytotoxic activity of an agent by at least 1.5-fold, 2-fold, 3-fold, 4-fold, 5-fold, 6-fold, 7-fold, 8-fold, 9-fold, 10-fold, 11-fold, 12-fold, 13-fold, 14-fold, 15-fold, 16-fold, 17-fold, 18-fold, 19-fold, 20-fold, 25-fold, 30-fold, 35-fold, 40-fold, 45-fold, 50-fold, 60-fold, 70-fold, 80-fold, 90-fold or 100-fold. In related embodiments, an inhibitor reduces the MIC of an agent by at least 5%, 10%, 15%, 20%, 25%, 30%, 35%, 40%, 45%, 50%, 55%, 60%, 65%, 70%, 75%, 80%, 85%, 90%, or 95%. In other embodiments, an inhibitor shift the therapeutic index of an agent, such that a patient may be treated with a dosage that is at least 5%, 10%, 15%, 20%, 25%, 30%, 35%, 40%, 45%, 50%, 55%, 60%, 65%, 70%, 75%, 80%, 85%, 90%, or 95% lower than the dosage used in the absence of an inhibitor.

Accordingly, the invention further provides methods of treating a subject diagnosed with or suspected of having an infection with a microorganism, comprising providing to the subject an appropriate antimicrobial agent in combination with an inhibitor of the present invention. In particular embodiments, the antimicrobial agent is provided at a dosage lower than previously used (i.e., in the absence of an inhibitor of the present invention.

Accordingly, the invention further provides methods of treating a subject diagnosed with or suspected of having an infection with a microorganism, comprising providing to the subject an appropriate antimicrobial agent in combination with an inhibitor of the present invention. In particular embodiments, the antimicrobial agent is provided at a dosage lower than previously used (i.e., in the absence of an inhibitor of the present invention).

Similarly, in other related embodiments, the invention further provides methods of treating a subject diagnosed with or suspected of having a tumor, comprising providing to the subject an appropriate chemotherapeutic agent in combination with an inhibitor of the present invention. In particular embodiments, the chemotherapeutic agent is provided at a dosage lower than previously used (i.e., in the absence of an inhibitor of the present invention).

The invention further includes a method of treating a subject diagnosed with or at risk of having a microbial infection, comprising providing an inhibitor of DNA repair or replication to said patient. In a related embodiment, the inhibitor is provided in combination with an antimicrobial agent.

In addition, the invention includes a method of treating a subject diagnosed with or suspected of having a tumor, comprising providing an inhibitor of DNA repair or replication to said patient. In a related embodiment, the inhibitor is provided in combination with a chemotherapeutic agent.

The methods described herein related to increasing or enhancing the activity of an antimicrobial or chemotherapeutic agent allow the use of dosages lower than those previously demonstrated effective in the absence of an inhibitor of the present invention. Such lower dosages offer significant advantages, including decreased side effects and decreased costs. Accordingly, in certain embodiments, methods of the present invention are practiced using dosages of antimicrobial or chemotherapeutic agent lower than those previously used. In addition, in particular embodiments, methods of the invention are practiced using antimicrobial or chemotherapeutic agents not generally used due to prohibitive side effects or high cost. For example, sparfloxacin is associated with a high incidence of photosensitivity, grepafloxacin is associated with QTc prolongation, and lomefloxacin is associated with a high incidence of photosensitivity.

The invention also provides methods of combating drug-resistant microorganisms and cells. Such methods may be used to reduce the growth of or kill drug-resistant microorganisms and cells. Depending upon the particular application of the method, the method typically comprises providing an inhibitor of DNA repair or replication to a subject or contacting a drug-resistant microorganism or cell with an inhibitor of DNA repair or replication. In one embodiment, the inhibitor is provided in combination with an antimicrobial or cytotoxic agent. For example, an inhibitor of the present invention can be used in combination with any antibiotic disclosed herein or otherwise known in the art. In certain embodiments, an inhibitor is used in combination with rifampin, an oxazolidinone (e.g., linezolid), a quinolone, a fluoroquinolone (e.g., ciprofloxacin, levofloxacin, moxifloxacin, gatifloxacin, gemifloxacin, ofloxacin, lomefloxacin, norfloxacin, enoxacin, sparfloxacin, temafloxacin, trovafloxacin, grepafloxacin), a macrolide (e.g., azithromycin and clarithromycin), or a later generation cephalosporin (e.g., cefaclor, cefadroxil, cefazolin, cefixime, cefoxitin, cefprozil, ceftazidime, cefuroxime, and cephalexin).

The inhibitors of the present invention can be administered to, provided to, or contacted with microorganisms or cells that are located within or on a subject. For example, the inhibitors may be provided to a subject having a microbial infection or tumor. Alternatively, the inhibitors may be contacted with microorganisms or cells that are not present within or on a subject. For example, inhibitors can be used to treat or kill a microorganism on a solid surface, such as a food preparation surface, or inhibitors can be used to treat or kill, or prevent the growth of, a microorganism in a food or beverage or pharmaceutical or cosmetic preparation.

In various embodiments, the methods of the invention are applied to any of a wide variety of microorganisms and cells, including all those described herein.

In certain embodiments, a method of the invention is applied to bacteria. In particular embodiments, the bacteria are gram positive or gram negative. In further embodiments, the bacteria are sensitive or resistant to one or more antibiotics. In particular embodiments, the bacteria comprise one or more mutations in a gene encoding a type II topoisomerase, e.g., the gyrase or topoisomerase gene, wherein the mutations are associated with drug resistance. The protein targets for certain antibiotics, e.g., quinolones, are type II topoisomerases (DNA gyrase and topoisomerase IV). Both are tetrameric enzymes with two A subunits and two B subunits, encoded by the gyrA and gyrB genes, respectively, in the case of DNA gyrase, and by the parC and parE genes in the case of topoisomerase IV. There is a region in these genes that is known as the quinolone resistance determining region (QRDR), where mutations associated with the acquisition of quinolone resistance have been located. Specific mutations identified as playing important roles in the acquisition of resistance are located in the QRDR of the gyrA and parc genes. Specific mutations identified as being associated with drug resistance include, e.g., mutation of amino acid resides Ser91 and Asp95 of GyrA and Glu91 and Ser87 of ParC. Furthermore, double mutations in Ser91 and Asp95 of GyrA plus mutation of Glu91 or Ser87 of ParC lead to significant high level drug resistance.

Accordingly, in particular embodiments, methods of the invention are applied to the treatment of bacteria having one or more mutations in gyrA, e.g., at Ser91 and/or Asp95, or having one ore more mutations in parC, e.g., Glu91 and/or Ser87. In a particular embodiment, a bacteria has one or more mutations in GyrA, as well as one or more mutations in ParC, including, but not limited to, the specific mutations described herein.

Relatedly, the invention includes methods of diagnosing the presence of a drug-resistant microorganism, e.g., bacteria, determining whether a microorganism has acquired drug resistance, and determining appropriate therapeutic treatment of a microorganism (or a patient infected with a microorganism), comprising determining the presence of a mutation associated with drug resistance in a microorganism. The presence of a mutation can be readily determined by a variety of different methods known and routinely used in the art, including, e.g., PCR analysis. A rapid PCR mismatch method of detecting mutations in gyrA and parC is described, e.g., in Ziang, Y. Z. et al., Journal of Antimicrobial Chemotherapy, 49: 549-552 (2002). In particular embodiments, the invention provides a methods of treating a drug-resistant microorganism, comprising determining the presence of one or more mutations associated with resistance and, if such a mutation is present, providing an inhibitor of DNA repair or replication to the microorganism. The inhibitor may be provided in the presence or absence of another antimicrobial agent.

Examples of bacteria treated according to methods of the invention include, but are not limited to: Baciccis Antracis; Enterococcus faecalis; Corynebacterium; diphtheriae; Escherichia coli; Streptococcus coelicolor; Streptococcus pyogenes; Streptobacillus moniliformis; Streptococcus agalactiae; Streptococcus pneumoniae; Salmonella typhi; Salmonella paratyphi; Salmonella schottmulleri; Salmonella hirshfeldii; Staphylococcus epidermidis; Staphylococcus aureus; Klebsiella pneumoniae; Legionella pneumophila; Helicobacter pylori; Moraxella catarrhalis, Mycoplasma pneumonia; Mycobacterium tuberculosis; Mycobacterium leprae; Yersinia enterocolitica; Yersinia pestis; Vibrio cholerae; Vibrio parahaemolyticus; Rickettsia prowazekii; Rickettsia rickettsii; Rickettsia akan; Clostridium difficile; Clostridium tetani; Clostridium perfringens; Clostridium novyii; Clostridium septicum; Clostridium botulinum; Legionella pneumophila; Hemophilus influenzae; Hemophilus parainfluenzae; Hemophilus aegyptus; Chlamydia psittaci; Chlamydia trachomatis; Bordetella pertusis; Shigella spp.; Campylobacter jejuni; Proteus spp.; Citrobacter spp.; Enterobacter spp.; Pseudomonas aeruginosa; Propionibacterium spp.; Bacillus anthracis; Pseudomonas syringae; Spirrilum minus; Neisseria meningitidis; Listeria monocytogenes; Neisseria gonorrheae; Treponema pallidum; Francisella tularensis; Brucella spp.; Borrelia recurrentis; Borrelia hermsii; Borrelia turicatae; Borrelia burgdorferi; Mycobacterium avium; Mycobacterium smegmatis; Methicillin-resistant Staphyloccus aureus; Vancomycin-resistant enterococcus; and multi-drug resistant bacteria (e.g., bacteria that are resistant to more than 1, more than 2, more than 3, or more than 4 different drugs).

In some embodiments, an inhibitor of the present invention is used to treat an already drug resistant bacterial strain such as Methicillin-resistant Staphylococcus aureus (MRSA) or Vancomycin-resistant enterococcus (VRE), including, but not limited to, any other drug-resistant strain described herein.

Accordingly, the inhibitors herein may be used to treat a wide variety of bacterial infections and conditions, such as intra-abdominal infections, ear infections, gastrointestinal infections, bone, joint, and soft tissue infections, sinus infections, bacterial infections of the skin, bacterial infections of the lungs, urinary tract infections, respiratory tract infections, sinusitis, sexually transmitted diseases, ophthalmic infections, tuberculosis, pneumonia, lyme disease, and Legionnaire's disease. Thus any of the above conditions and other conditions resulting from bacterial infections may be prevented or treated by the compositions herein.

In specific embodiments, methods of the present invention are used to treat any classification of urinary tract infection (UTI), and UTIs caused by any microorganism. Examples of these include, but are not limited to: uncomplicated UTI, of which 85% is caused by E. coli and the remainder by S. saprophyticus, Proteus spp., and Klebseiella spp; complicated UTIs, associated with gram-negative organisms, including E. coli, P. aeuroginosa, and E. facecalis; and

recurrent UTIs, 80% of which are caused by an organism different from the organism isolated from the preceding infection, and the remaining 20% are relapses, possibly due to persistence of infection with the same organisms after therapy. E. coli is the most common bacterium isolated from UTIs and accounts for about 80% of community-acquired infections, while Staphylococcus saprophyticus accounts for about 10%. In hospitalized patients, E. coli accounts for about 50% of cases, the gram-negative species Klebsiella, Proteus, Enterobacter and Serratia account for about 40%, and the gram-positive bacterial cocci Enterococcus faecalis and Staphylococcus spp (e.g., saprophyticus and aureus) account for most of the remainder.

In specific examples of embodiments of the present invention, an inhibitor is used to treat: a respiratory tract infection with Streptococcus, alone or in combination with levofloxacin; a respiratory or urinary tract infection with P. aeuroginosa, alone or in combination with ciprofloxacin; or a urinary tract infection with E. coli alone or in combination with ciprofloxacin.

In particular embodiments, an inhibitor of the present invention is used to treat a microorganism used in biowarfare. Biowarfare and bioterrorism have been defined as the intentional or the alleged use of viruses, bacteria, fungi and toxins to produce death or disease in humans, animals or plants. Of these various biowarfare agents, bacteria and viruses appear to pose the most significant threat of widespread harm, primarily due to their relative ease of both production and transmissibility, as well as a lack of medical treatments. Examples of known viruses considered suitable as biowarfare agents include smallpox virus, and the hemorrhagic fever viruses, such as ebola virus, amongst others. Although there are currently a limited number of known viruses considered suitable as biowarfare agents, many more might be made suitable through genetic engineering or other modifications. Discussed in Kostoff, R. N. The Scientist 15:6 (2001). Such novel viral agents present a particular threat, since vaccines and methods of detection and treatment would likely not exist.

Examples of biowarfare bacteria and spores that may be treated according to the present invention include, but are not limited to, Bacillus anthracis, Bacillus cereus, Clostridium botulinum, Yersinia pestis, Yersinia enterocolitica, Francisella tularensis, Brucella species, Clostridium perfringens, Burkholderia mallei, Burkholderia pseudomallei, Staphylococcus species, Tuberculosis species, Escherichia coli, Group A Streptococcus, Group B Streptococcus, Streptococcus pneumoniae, Helicobacter pylori, Francisella tularensis, Salmonella enteritidis, Mycoplasma hominis, Mycoplasma orale, Mycoplasma salivarium, Mycoplasma fennentans, Mycoplasma pneumoniae, Mycobacterium bovis, Mycobacterium tuberculosis, Mycobacterium avium, Mycobacterium leprae, Rickettsia rickettsii, Rickettsia akari, Rickettsia prowazekii, Rickettsia canada, and Coxiella burnetti.

Examples of yeast and other fungi that may be treated according to the present invention include, but are not limited to, Aspergillus species (e.g. Aspergillus niger), Mucorpusillus, Rhizopus nigricans, Candida species (e.g. Candida albicans, Candida dubliniensis, C. parapsilosis, C. tropicalis, and C. pseudotropicalis), Torulopsis glabrata, Blastomyces dermatitidis, Coccidioides immitis, Histoplasma capsulatum, Cryptococcus neoformans, and Sporothrix schenckii.

Viral infections that may be treated by the methods and compositions of the present invention include those caused by both DNA and RNA viruses. DNA viruses may comprise a double-stranded DNA genome (e.g., smallpox) or a single-stranded DNA genome (e.g., adeno-associated virus). RNA viruses include those with genomes comprising antisense RNA (e.g., Ebola), sense RNA (e.g., poliovirus), or double-stranded RNA (e.g., reovirus), as well as retroviruses (e.g., HIV-1). Examples of DNA viruses and associated diseases that may be treated by the invention include: variola (smallpox); herpes viruses, such as herpes simplex (cold sores), varicella-zoster (chicken pox, shingles), Epstein-Barr virus (mononucleosis, Burkift's lymphoma), KSHV (Kaposi's sarcoma), and cytomegalovirus (blindness); adenoviruses; and hepatitis B. Examples of RNA viruses include polioviruses, rhinociruses, rubella, yellow fever, West Nile virus, dengue, equine encephalitis, hepatitis A and C, respiratory syncytial virus, parainfluenza virus, and tobacco mosaic virus. RNA viruses have been implicated in a variety of human diseases that may be treated by the invention, including, for example, measles, mumps, rabies, Ebola, and influenza. Viral infections treated by the invention may be localized to specific cells or tissues, or they may be systemic. In addition, these viral infections may be either lytic or latent.

Compositions and methods of the present invention may, therefore, be used to treat diseases, including, but not limited to, cutaneous anthrax, inhalation anthrax, gastrointestinal anthrax, nosocomical Group A streptococcal infections, Group B streptococcal disease, meningococcal disease, blastomycocis, streptococcus pneumonia, botulism, Brainerd Diarrhea, brucellosis, pneumonic plague, candidiasis (including oropharyngeal, invasive, and genital), drug-resistant Streptococcus pneumoniae disease, E. coli infections, Glanders, Hansen's disease (Leprosy), cholera, tularemia, histoplasmosis, legionellosis, leptospirosis, listeriosis, meliodosis, mycobacterium avium complex, mycoplasma pneumonia, tuberculosis, peptic ulcer disease, nocardiosis, chiamydia pneumonia, psittacosis, salmonellosis, shigellosis, sporotrichosis, strep throat, toxic shock syndrome, trachoma, traveler's diarrhea, typhoid fever, ulcer disease, and waterborne disease.

The methods and compositions of the present invention may also be used to treat systemic viral infections that can lead to severe hemorrhagic fever. Although many viral infections can be associated with hemorrhagic complications, infection with any of several RNA viruses regularly results in vascular involvement and viral hemorrhagic fever. Known viral hemorrhagic fevers include Ebola hemorrhagic fever, Marburg disease, Lassa fever, Argentine haemorrhagic fever, and Bolivian hemorrhagic fever. Etiologic agents for these disease include Ebola virus, Marburg virus, Lassa virus, Junin virsus, and Machupo virus, respectively.

A variety of viruses are associated with viral hemorrhagic fever, including filoviruses (e.g., Ebola, Marburg, and Reston), arenaviruses (e.g. Lassa, Junin, and Machupo), and bunyaviruses. In addition, phleboviruses, including, for example, Rift Valley fever virus, have been identified as etiologic agents of viral hemorrhagic fever. Etiological agents of hemorrhagic fever and associated inflammation may also include paramyxoviruses, particularly respiratory syncytial virus, since paramyxoviruses are evolutionarily closely related to filoviruses (Feldmann, H. et al. Arch Virol Suppl 7:81-100 (1993)). In addition, other viruses causing hemorrhagic fevers in man have been characterized as belonging to the following virus groups: togavirus (Chikungunya), flavivirus (dengue, yellow fever, Kyasanur Forest disease, Omsk hemorrhagic fever), nairovirus (Crimian-Congo hemorrhagic fever) and hantavirus (hemorrhagic fever with renal syndrome, nephropathic epidemia). Furthermore, Sin Nombre virus was identified as the etiologic agent of the 1993 outbreak of hantavirus pulmonary syndrome in the American Southwest.

In other embodiments, an inhibitor of the present invention is used in combination with an antiviral agent, including but not limited: AZT; Ganciclovir; valacyclovir hydrochloride (Valtrex™); Beta Interferon; Cidofovir; Ampligen™; penciclovir (Denavir™), foscarnet (Foscavir™), famciclovir (Famvir™), acyclovir (Zovirax™), and any others recited herein.

Examples of viruses that may be treated according to methods of the present invention include, but are not limited to, human immunodeficiency virus (HIV); influenza; avian influenza; ebola; chickenpox; polio; smallpox; rabies; respiratory syncytial virus (RSV); herpes simplex virus (HSV); common cold virus; severe acute respiratory syndrome (SARS); Lassa fever (Arenaviridae family), Ebola hemorrhagic fever (Filoviridae family), hantavirus pulmonary syndrome (Bunyaviridae family), and pandemic influenza (Orthomyxoviridae family).

In another example, an inhibitor is used in combination with an antiprotozoan agent selected from the group consisting of: Chloroquine; Pyrimethamine; Mefloquine Hydroxychloroquine; Metronidazole; Atovaquone; Imidocarb; Malarone™; Febendazole; Metronidazole; Ivomec™; Iodoquinol; Diloxanide Furoate; and Ronidazole.

Examples of protozoan organisms that are treated using methods of the present invention include, but are not limited to, Acanthameba; Actinophrys; Amoeba; Anisonema; Anthophysa; Ascaris lumbricoides; Bicosoeca; Blastocystis hominis; Codonella; Coleps; Cothurina; Cryptosporidia Difflugia; Entamoeba histolytica (a cause of amebiasis and amebic dysentery); Entosiphon; Epaixis; Epistylis; Euglypha; Flukes; Giardia lambia; Hookworm Leishmania spp.; Mayorella; Monosiga; Naegleria Hartmannella; Paragonimus westermani; Paruroleptus; Plasmodium spp. (a cause of Malaria) (e.g., Plasmodium falciparum; Plasmodium malariae; Plasmodium vivax and Plasmodium ovale); Pneumocystis carinii (a common cause of pneumonia in immunodeficient persons); microfilariae; Podophrya; Raphidiophrys; Rhynchomonas; Salpingoeca; Schistosoma japonicum; Schistosoma haematobium; Schistosoma mansoni; Stentor; Strongyloides; Stylonychia; Tapeworms; Trichomonas spp. (e.g., Trichuris trichiuris and Trichomonas vaginalis (a cause of vaginal infection)); Typanosoma spp.; and Vorticella.

In other embodiments, an inhibitor of the present invention is used in combination with an antifungal agent selected from the group consisting of: imidazoles (e.g., clotrimazole, miconazole; econazole, ketonazole, oxiconazole, sulconazole), ciclopiroz, butenafine, and allylamines.

Examples of fungus infections that can be treated with an inhibitor (+/−an antifungal agent) according to methods of the invention include, but are not limited to, tinea; athlete's foot; jock itch; and candida.

In particular embodiments, the present invention contemplates the prevention and treatment of the following infectious diseases caused by the indicated agents, which have re-emerged with increased resistance to medications: Cryptosporidiosis (Cryptosporidium parvum (protozoan)); Diphtheria (Corynebacterium diptheriae (bacterium)); Malaria (Plasmodium species (protozoan)); Meningitis, necrotizing fasciitis (flesh-eating disease), toxic-shock syndrome, and other diseases (Group A Streptococcus (bacterium)); Pertussis (whooping cough) (Bordetella pertussis (bacterium)); Rabies (Rhabdovirus group (virus)); Rubeola (measles) (Morbillivirus genus (virus)); Schistosomiasis (Schistosoma species (helminth)); Tuberculosis (Mycobacterium tuberculosis (bacterium)); Yellow fever (Flavivirus group (virus)); and HIV (Staphylococcus).

As discussed earlier, pathways comparable to the bacterial pathways discussed herein are also known to exist in eukaryotic cells. Accordingly, in certain embodiments, inhibitors of the present invention are used to treat eukaryotic cells, including, e.g., mammalian cells. In one embodiment, an inhibitor is used to treat a drug-resistant tumor. In another embodiment, an inhibitor is used in combination with a chemotherapeutic agent to treat a drug-sensitive or drug-resistant tumor. The inhibitors may be used to treat or prevent both benign and malignant tumors.

Examples of cancers that are treatable or preventable by the present invention include, but are not limited to, breast cancer; skin cancer; bone cancer; prostate cancer; liver cancer; lung cancer; brain cancer; cancer of the larynx; gallbladder; pancreas; rectum; parathyroid; thyroid; adrenal; neural tissue; head and neck; colon; stomach; bronchi; kidneys; basal cell carcinoma; squamous cell carcinoma of both ulcerating and papillary type; metastatic skin carcinoma; osteo sarcoma; Ewing's sarcoma; veticulum cell sarcoma; myeloma; giant cell tumor; small-cell lung tumor; gallstones; islet cell tumor; primary brain tumor; acute and chronic lymphocytic and granulocytic tumors; hairy-cell leukemia; adenoma; hyperplasia; medullary carcinoma; pheochromocytoma; mucosal neuromas; intestinal ganglioneuromas; hyperplastic corneal nerve tumor; marfanoid habitus tumor; Wilm's tumor; seminoma; ovarian tumor; leiomyomater tumor; cervical dysplasia and in situ carcinoma; neuroblastoma; retinoblastoma; soft tissue sarcoma; malignant carcinoid; topical skin lesion; mycosis fungoide; rhabdomyosarcoma; Kaposi's sarcoma; osteogenic and other sarcoma; malignant hypercalcemia; renal cell tumor; polycythermia vera; adenocarcinoma; glioblastoma multiforme; leukemias (including acute myelogenous leukemia); lymphomas; malignant melanomas; epidermoid carcinomas; chronic myleoid lymphoma; gastrointestinal stromal tumors; and melanoma.

An inhibitor of DNA repair, recombination, and replication, may be used in combination with an antimicrobial or chemotherapeutic agent that targets a DNA replication or repair pathway, such as a fluoroquinolone. However, it is further understood according to the present invention that inhibitors of DNA repair or replication may also be used to enhance sensitivity to agents that act via different mechanisms. Since the inhibitors of DNA repair, recombination, and replication target fundamental cellular processes, they are generally somewhat crippling to microorganisms and cells, and therefore, synergize or cooperate additively with agents that target other pathways. For example, an inhibitor of RecB would block induction of RecA gene expression mediated via the SOS pathway. Accordingly, the methods of the present invention are applicable to agents that act on DNA repair or replication pathways, as well as agents that act on different cellular targets.

### EXAMPLES

The Examples below demonstrate that inhibiting the function of certain gene products involved in DNA repair and/or replication enhances the sensitivity of both drug-resistant and drug-sensitive microorganisms and cells to antimicrobial and cytotoxic compounds. In addition, the Examples further demonstrate the inhibiting the function of certain gene products involved in DNA repair and/or replication reduces the viability of drug-resistant microorganisms and cells.

### Example 1

### RecA, RecB, RecG, priA, RuvB and ruvC Mutants Exhibit an Increased Sensitivity to Sublethal Doses of Ciprofloxacin

The contribution of different components of DNA recombination and repair pathways in mediating ciprofloxacin resistance was determined by examining the effect of various mutations. The experiments were performed using the E. coli strain MG1655 as the genetic background, since this K-12 strain was used in the E. coli genome sequencing project. Strains listed in Table 1 were constructed using PCR-mediated gene replacement. See Murphy, K C, et al., Gene 2000, 246:321-330. PCR reactions were performed using Platinum pfx DNA polymerase from Invitrogen, with standard cycling parameters. Genomic template DNA was prepared from a fresh bacterial overnight culture using the DNeasy kit (Qiagen).

The kanamycin cassette was PCR amplified from a pUC4K plasmid using primers 5′-GGA AAG CCA CGT TGT GTC TC and 5′-CGA TTT ATT CAA CAA AGC CGC. Gene specific components from each gene were amplified from MG1655 genomic DNA to obtain two PCR products: the ‘N-fragment’ containing 500 base pairs upstream and including the first two to three codons and the ‘C-fragment’ containing the last two to three codons and 500 base pairs downstream. The fragment ends were engineered to contain the reverse complement of the kanamycin cassette sequence at their internal sites by using primers with 20 base pairs of homology and a 20 base pair tail complementary to the kanamycin cassette ends at the 3′-end for the N fragment and at the 5′-end for the C fragment.

TABLE 1
Mutated strains

| Parent | Mutation |
|---|---|
| MG1655 | — |
| ATCC25922 | — |
| MG1655 | DY329 (nadA::RED) |
| MG1655 | lacZΔ::kan |
| MG1655 | polBΔ::kan |
| MG1655 | polBΔ::spc |
| MG1655 | dinBΔ::kan |
| MG1655 | umuDCΔ::kan |
| MG1655 | umuDCΔ::cat |
| MG1655 | polBΔ::Spc, dinBΔ::kan |
| MG1655 | polBΔ::Spc, umuDCΔ::kan |
| MG1655 | dinBΔ::kan umuDCΔ::cat |
| MG1655 | polBΔ::spc dinBΔ::kan, UmuDC::Cat |
| MG1655 | LexA(S119A)::kan |
| MG1655 | recAΔ::kan |
| MG1655 | recBΔ::kan |
| MG1655 | recDΔ::kan |
| MG1655 | recFΔ::kan |
| MG1655 | recGΔ::kan |
| MG1655 | ruvBΔ::kan |
| MG1655 | ruvCΔ::kan |
| MG1655 | sulAΔ::kan |
| MG1655 | priAΔ::kan |
| ATCC25922 | lacZΔ::kan |
| ATCC25922 | LexA(S119A)::kan |
| ATCC25922 | recFΔ::kan |

To create the full, gene-specific disruption cassettes, the products of the N-fragment, C-fragment and kanamycin cassette reactions were combined in a PCR reaction, in equal volume. Conditions for this PCR reaction were standard, with the exception that the proximal primers were used in limiting amounts. The excess distal primer is consumed in the second PCR reaction. The complementary sequences on the N- and C-fragments acted as primers for the kanamycin cassette, which resulted in a final product containing approximately 500 base pairs of upstream sequence, the kanamycin cassette in a reverse orientation to the gene that was knocked out, and 500 base pairs of downstream sequence.

Generation of the genomic deletions in MG1655 proceeded in two steps: (i) genomic insertion into strain MG-DY329 and (ii) P1-mediated transfer of the deletion cassette to MG1655. In the first step, the linear DNA fragments (PCR products) were electroporated into the hyper-recombinational E. coli strain MG-DY329 [Yu, D, et al. Proc Natl Acad Sci USA (2000) 97:5978-5983], a derivative of MG1655 which carries the lambda phage red genes. This strain accepted the linear PCR product and recombined it into the genome with high efficiency. Recombination genes were activated by growing DY329 at 42° C. and the competent cells stored at −80° C. The competent cells were transformed with the desired kanamycin cassette and kan transformants selected at 30° C.

Although MG-DY329 was engineered such that the lambda phage red genes could be easily removed to return the cell to a non-hyper-recombinational background, P1 transduction was utilized to move the gene-specific disruption from MG-DY329 into MG1655. MG1655 provides a more ‘wild-type’ background than MG-DY329, and thus simplifies the interpretation of the results. Gene deletions were verified by PCR.

The ΔlacZ strain was constructed as a control. The ΔlacZ strain exhibited wild-type growth and mutation (+/−1.15-fold) and is, therefore, also referred to herein as “wild-type.”

TABLE 2
Doubling time and sensitivity to ciprofloxacin of E. coli mutants.

| | Relative | | | |
|---|---|---|---|---|
| | Doubling | ciprofloxacin MIC (ng/ml) | | |
| E. coli strain | Time | WT gyrA | gyrA S83Δ | gyrA S83L |
| MG1655 | 1.00 (±0.00) | 35 | nd | 500 |
| ΔlacZ | 1.03 (±0.01) | 35 | 250 | 500 |
| ΔdinB | 1.01 (±0.03) | 35 | 250 | 500 |
| ΔumuDC | 1.02 (±0.02) | 35 | 250 | 500 |
| ΔpolB, ΔdinB, | 1.09 (±0.13) | 30 | 250 | 500 |
| ΔumuDC | | | | |
| lexA(S119A) | 1.00 (±0.01) | 30 | 250 | 350 |
| ΔrebD | 1.01 (±0.02) | 30 | nd | 350 |
| ΔrecF | 1.02 (±0.02) | 40 | nd | 400 |
| ΔrecO | 0.99 (±0.01) | 35 | nd | 500 |
| ΔrecR | 0.99 (±0.02) | 35 | nd | 350 |
| ΔuvrB | 0.99 (±0.01) | 30 | nd | 400 |
| ΔrecQ | 0.97 (±0.02) | 30 | nd | 500 |
| ΔrecA | 1.13 (±0.10) | 5 | nd | nd |
| ΔrecB | 1.22 (±0.14) | 5 | nd | nd |
| ΔrecG | 1.01 (±0.03) | 10 | nd | 150 |
| ΔruvB | 1.08 (±0.01) | 10 | nd | 150 |
| ΔruvC | 1.07 (±0.10) | 10 | nd | 150 |

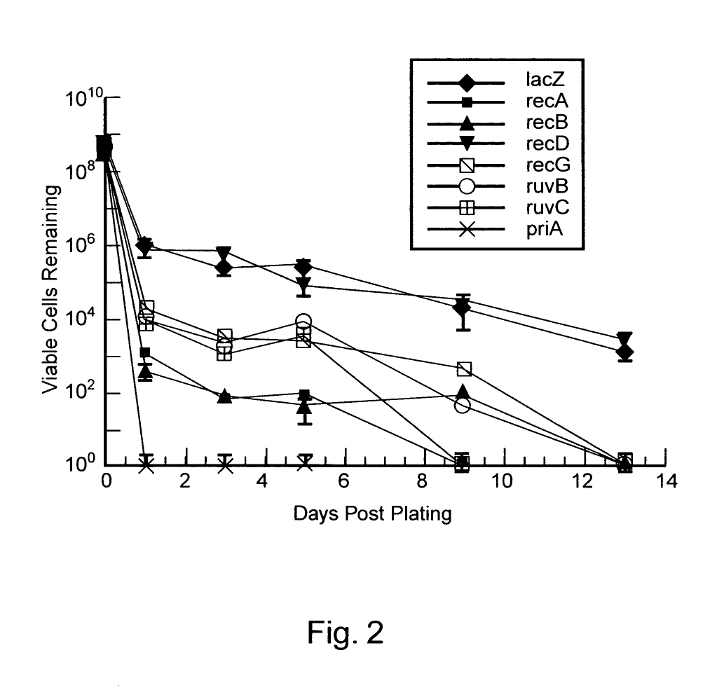

The ciprofloxacin MIC was determined for the wild-type and mutant strains and is provided in Table 2 (WT gyrA column). The MIC for wild-type was 35 ng/ml in liquid media. On solid media, 40 ng/ml ciprofloxacin killed 99% of the cells within 24 hours of plating (FIG. 2). The majority of deletions had little or no effect on the MIC.

Surprisingly, however, the MIC for both the ΔrecA and ΔrecB strains was only 5 ng/ml, indicating that these strains had increased sensitivity to ciprofloxacin as compared to wild-type (although both exhibited virtually wild-type viability in the absence of ciprofloxacin). In addition, no pre- or post-exposure ciprofloxacin resistant mutants were observed in SLAM assays on the ΔrecA or ΔrecB strains (data not shown; see Example 2), indicating that these deletions prevented either the emergence or maintenance of ciprofloxacin resistance.

In contrast, deletion of recD had little or no effect on drug sensitivity (Table 2 and FIG. 2), mutation rate, or mutation spectrum. This result is consistent with the fact that RecBC can process DSEs and load RecA onto ssDNA in the absence of the RecD helicase.

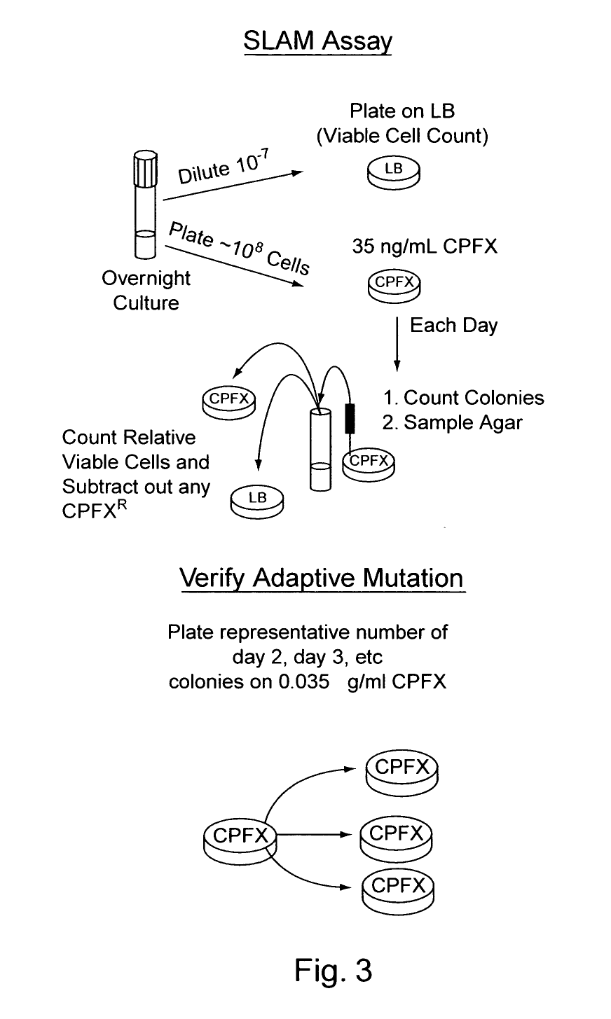

The potential steps before and after RecBC(D) and RecA-mediated recombination were examined with ΔrecG, ΔruvB, and ΔruvC strains, since RecG, RuvB, and RuvC are known to be involved in the regression of stalled replication forks and/or the processing of HR intermediates. Deletion of RecG, ruvB, or ruvC did not cause a significant decrease in viability in the absence of ciprofloxacin, but did show high sensitivity to the drug, although not as great as the ΔrecA and ΔrecB strains (Table 2 and FIG. 2). Also, like the ΔrecA and ΔrecB strains, no ciprofloxacin-resistant mutants were isolated from SLAM assays (FIG. 3; see Example 2) on the ΔrecG, ΔruvB, and ΔruvC strains, either before or after exposure to ciprofloxacin. Furthermore, although it was possible to delete recG, ruvB, and ruvC in a gyrA(S83L) background by P1 transduction, the three double mutants were synthetically sick, exhibited increased filamentation relative to the respective single mutants, and had a low ciprofloxacin MIC relative to the gyrA(S83L) parent strain (Table 2). These results demonstrate that the functions of RecG, RuvAB, and RuvC are required in the presence of ciprofloxacin or certain gyrase mutations that confer ciprofloxacin resistance.

To determine if the resumption of processive DNA synthesis is required in response to ciprofloxacin, a ΔpriA strain was examined. Deletion of priA resulted in extreme sensitivity to ciprofloxacin (MIC <1 ng/ml), demonstrating that replication restart is essential in response to the drug (FIG. 2). No mutants were isolated before or after exposure to ciprofloxacin, and a gyrA(S83L) ΔpriA double mutant could not be constructed.

The unexpected results of these studies establish that the RecBC(D)-mediated HR plays an important role in DNA repair processes important for the survival of drug resistant strains having compromised gyrase function, and that inhibition of DNA repair and replication pathways renders bacteria more sensitive to ciprofloxacin than wild type strains. In addition, they demonstrate that replication restart is essential in response to ciprofloxacin and may play a role in tolerating the effects of resistance-conferring gyrase mutations. Accordingly, these findings establish that RecBC(D) and other components of double-stranded break repair or stalled replication fork rescue or repair pathways are required for the repair of DNA damage caused by ciprofloxacin. Accordingly, these studies indicate that RecBC(D) and RecA, as well as PriA, RecG, RuvB, and RuvC, are important targets in the treatment of both sensitive and resistant strains, and demonstrate that inhibitors of these polypeptides (or other polypeptides involved in double-stranded DNA break repair, replication restart, or fork repair) can be used to increase the drug sensitivity of and, ultimately, reduce viability or kill both sensitive and resistant strains.

### Example 2

### The Roles of Various Genes in Determining Sensitivity to Ciprofloxacin and the Ability to Evolve Resistance to Ciprofloxacin

With the isogenic loss of function strains in hand, mutation in response to ciprofloxacin (obtained from U.S. Biologicals) was determined using a protocol based on the Stressful Lifestyle Adaptive Mutation (SLAM) assay, as depicted in FIG. 3. Five colonies of each strain, selected from 30 ug/mL kan plates, were grown for 24 hours in LB at 37° C. Dilutions of each culture were made in duplicate and plated on LB plates to determine the number of viable cells.

To assay for mutation, 150 μL of each culture was plated twice on LB plates containing 35 ng/mL ciprofloxacin. Also, two 150 μL cultures from each strain were plated on five additional plates for use in ‘survival’ experiments (see below). The concentration of ciprofloxacin used was chosen based on trial experiments with the MG1655 parent strain which indicated that 35 ng/mL ciprofloxacin maximized mutation-dependent growth. Every twenty-four hours for thirteen days post-plating, colonies were counted and marked and up to 10 representative colonies per strain were stocked in 15% glycerol and stored at −80° C., for use in the reconstruction experiments (see below). Also, to determine the number of ciprofloxacin susceptible cells remaining on the plates, parallel ‘survival’ experiments were performed. The ‘survival’ experiment plates were treated exactly as the SLAM plates, except at specified time points, representative plates were sacrificed by excising all visible colonies, recovering the remaining agar in 9 mg/mL saline, and plating dilutions of the resulting solution on LB to determine the number of viable cells.

After thirteen days, a reconstruction experiment (Bull, H J, et al., Proc Natl Acad Sci USA (2001) 98:8334-8341; and Rosenberg, S M, (2001) Nat. Rev. Genet. 2:504-515) was performed to determine which of the resistant colonies isolated had evolved resistance via induced mutation after exposure to the antibiotic. The stocked colony suspensions isolated during the original experiment were used to inoculate 1 mL of LB and grown overnight at 37° C. The resulting cultures were then diluted and duplicate plated on LB and LB containing 35 ng/mL ciprofloxacin, and the time elapsed to colony formation was recorded and compared to the original experiment. Only those colonies that grew in a shorter time during the reconstruction experiment than in the original experiment were considered to have acquired an induced mutation, i.e., occurred after exposure to the antibiotic. Using the colony counts of induced mutants on the ciprofloxacin containing SLAM plates and the viable cell counts from the ‘survival’ experiments, an induced mutation rate was calculated per viable cell.

The data from these experiments are shown in Table 3. As indicated the frequency of mutation to ciprofloxacin resistance was found to be significantly reduced in several strains, including polBΔ (Pol II deletion strain); dinBΔ (Pol IV deletion strain); umuDCΔ (Pol V deletion stain), and lexA(Ind⁻) (which cannot under autocleavage and thus makes the strain uninducible). The largest effect from any single mutation was seen for the LexA(Ind⁻) strain which had a reduction of more than two orders of magnitude in the frequency of developing resistance to ciprofloxacin (the precise amount depending on the antibiotic concentration). The observed effect is remarkably large when considered in the context of clinical resistance. Clinically relevant high resistance requires multiple independent mutations. See Drlica, K, et al. Microbiol Mol. Biol. Rev. (1997) 61:377-392; Gibreel, A, et al. Antimicrob. Agents Chemother. (1998) 42:3276-3278; Kaatz, G W, Antimicrob Agents Chemother. (1993) 37:1086-1094; Yoshida, H, et al. J. Bacteriol., (1990) 172:6942-6949; Poole, K., Antimicrob. Agents Chemother. (2000) 44:2233-2241; Kern, W V, Antimicrob. Agents Chemother. (2000) 44:814-820; Fukuda, H, Antimicrob. Agents Chemother. (1998) 42:1917-1922, whereas resistance in these experiments requires a single mutation (in the gyrA gene, confirmed by sequencing).

TABLE 3
Strain growth, ciprofloxacin sensitivity, and mutation spectra

| | | | | | | | | Post-ciprofloxacin | | |
|---|---|---|---|---|---|---|---|---|---|---|
| | | ciprofloxacin | | | | | | Exposure | | |
| | | MIC | | | Exponential Growth | | | Day 5-13 Mutation | | |
| | Relative | (ng/ml) | | | Mutation Spectra | | | Spectra | | |
| | Doubling | WT | gyrA | gyrA | % | % Base | % | % | % Base | % |
| Strain | Time | gyrA | S83Δ | S83L | WT | Substitution | Codon Δ | WT | Substitution | Codon Δ |
| ΔlacZ | 1.0 (±0.01) | 35.0 | 250.0 | 450 | 16.7 | 83.3 | 0.0 | 22.2 | 61.2 | 16.7 |
| ΔpolB | 1.1 (±0.10) | 30.0 | 250.0 | 450 | 28.6 | 71.4 | 0.0 | 0.0 | 0.0 | 100.0 |
| ΔdinB | 1.0 (±0.03) | 35.0 | 250.0 | 450 | 16.7 | 83.3 | 0.0 | 0.0 | 0.0 | 100.0 |
| ΔumuDC | 1.0 (±0.01) | 35.0 | 250.0 | 450 | 25.0 | 75.0 | 0.0 | 33.3 | 0.0 | 66.7 |
| ΔpolB, ΔdinB | 1.0 (±0.12) | 25.0 | 250.0 | 450 | 50.0 | 50.0 | 0.0 | 83.3 | 0.0 | 16.7 |
| ΔpolB, | 1.1 (±0.19) | 25.0 | 250.0 | 450 | 66.7 | 33.3 | 0.0 | 0.0 | 0.0 | 100.0 |
| ΔumuDC | | | | | | | | | | |
| ΔdinB, | 1.1 (±0.08) | 35.0 | 250.0 | 450 | 16.7 | 83.3 | 0.0 | 33.3 | 0.0 | 66.7 |
| ΔumuDC | | | | | | | | | | |
| ΔpolB, | 1.2 (±0.17) | 25.0 | 250.0 | 450 | 42.9 | 57.1 | 0.0 | 0.0 | 0.0 | 100.0 |
| ΔdinB, | | | | | | | | | | |
| ΔumuDC | | | | | | | | | | |
| lexA (S119A) | 1.0 (±0.03) | 30.0 | 250.0 | 350 | 16.7 | 83.3 | 0.0 | 0.0 | 0.0 | 100.0 |
| ΔrecD | 1.0 (±0.10) | 35.0 | 250.0 | 350 | 0.0 | 100.0 | 0.0 | 0.0 | 80.0 | 20.0 |
| ΔrecA | 1.1 (±0.02) | 5.0 | | | | | | | | |
| ΔrecB | 1.1 (±0.04) | 7.5 | | | | | | | | |
| ΔrecG | 1.0 (±0.02) | 10.0 | | | | | | | | |
| ΔruvB | 1.1 (±0.14) | 10.0 | | | | | | | | |
| ΔruvC | 1.0 (±0.04) | 10.0 | | | | | | | | |
| ΔpriA | 1.1 (±0.04) | <1.0 | | | | | | | | |

The ΔlacZ strain was constructed as a control, and exhibited wild-type growth and mutation (±1.15-fold) in all cases. Other strains were constructed and characterized to examine the contribution of recombination and the SOS response to the survival in the presence of the antibiotic, and to the evolution of resistance.

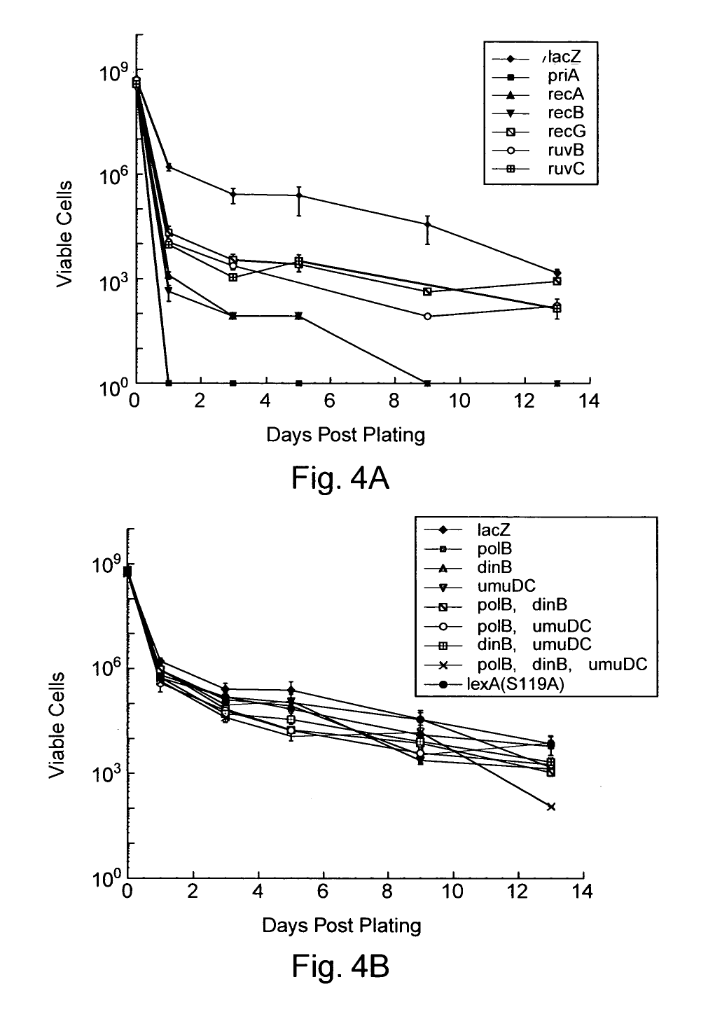

Given the apparent importance of recombination dependent replication restart to induced mutation at the lac allele, its role in response to ciprofloxacin was examined (FIG. 4). Deletion of priA, whose protein product facilitates replication restart after replication fork collapse by reloading replisome proteins, resulted in an extreme sensitivity to the antibiotic (MIC<1 ng/ml ciprofloxacin), implying that replication restart is required in response to the drug. This conclusion remains valid even in the presence of possible suppressor mutations (common in ΔpriA strains), because the strain remains hypersensitive to ciprofloxacin. recA and recB encode proteins required for recombination. The ΔrecA and ΔrecB strains exhibited nearly wild-type growth in the absence of ciprofloxacin, but were both hypersensitive to the antibiotic. The ΔrecG, ΔruvB, and ΔruvC strains, lacking the corresponding proteins involved in processing recombination intermediates, also showed no major growth defects in the absence of ciprofloxacin, and a high sensitivity to the drug, although not as great as the ΔrecA and ΔrecB strains. While the hypersensitivity to ciprofloxacin precludes determination of a post-exposure mutation rate in these strains (no resistant colonies could be isolated), it indicates that recombination-dependent replication restart becomes essential in the presence of ciprofloxacin, even at the low concentrations used in these experiments. In contrast, deletion of recD had no effect on the sensitivity to the antibiotic or the rate of mutation, implying that resectioning to a Chi sequence is not critical for repair of ciprofloxacin induced DNA damage. The lexA(S119A) strain showed virtually wild-type sensitivity to ciprofloxacin, implying that induction of the SOS response is not required as a response to the drug at this low concentration. However, the frequency with which bacteria evolved resistance to 35 ng/mL ciprofloxacin was reduced by approximately 100-fold in this strain (data not sown). These observations establish that RecA, RecB, RecG, RuvB, RuvC and PriA are attractive targets for the development of drugs that hypersensitize bacteria to ciprofloxacin, other quinolones, and other DNA damaging agents.

### Example 3

### Deletion of recB Sensitizes Both FQ^{S} and FQ^{R} Strains to Ciprofloxacin

To investigate the effect of recB mutation in FQ^{r} gyrA mutants, the recB gene was deleted from gyrA FQ^{r} mutants, and these strains were assayed for ciprofloxacin response (Table 4). The deletion of recB was carried out using P1-mediated transduction of a recB::Km^{r} allele into strains harboring gyrA FQ^{r} mutations, including gyrA-S83L in two different strain backgrounds, and gyrA-D87G.

Notably, it was demonstrated that deletion of recB from each of the gyrA FQ^{r} mutant strains significantly re-sensitized the strains to ciprofloxacin, 5- to 8-fold depending upon the strain background and the specific gyrA* mutation. In addition, deletion of recB from a wild-type FQ-sensitive strain sensitized the strain approximately 8-fold. Taken together, these results demonstrate that an inhibitor of RecB is an effective combination therapy with fluoroquinolone antibiotics against both FQ-sensitive as well as FQ-resistant infections.

TABLE 4
Ciproflaxocin MICs of ΔrecB gyrA* strains

ciprofloxacin MIC (ng/ml)

| E. coli strain | recB+ | ΔrecB |
|---|---|---|
| MG1655 (gyrA+) | 25 | 3 |
| MG1655 gyrA-S83L | 500 | 100 |
| AB1157 gyrA-D87G | 200 | 25 |
| DM4100 gyrA-S83L | 400 | 50 |

Interestingly, it was found that the efficiency of general P1 transduction was approximately 10-fold lower using the ΔrecB strain as a P1 donor compared to control donors. Also, the efficiency of general P1 transduction into the gyrA FQ^{r} (gyrA*) mutant strains was approximately 20-fold less efficient compared to control recipients. The combination of these factors resulted in a greatly reduced efficiency of the ΔrecB allele into gyrA* backgrounds, but transductant colonies were still obtained.

Because of the very low efficiency of transduction observed, several steps were taken to confirm the genotype of each ΔrecB gyrA* strain. The presence of the ΔrecB allele was confirmed using three methods. First, attempts were made to PCR amplify the recB locus from the putative ΔrecB strains and recB+ controls. The recB+ locus was PCR amplified from all recB+ parental strains, but a product was not amplified from any of the putative ΔrecB strains. Second, the ΔrecB strains were tested in a P1 plaque assay. It was observed that rec+ strains are able to support P1 plaque formation, while rec− strains (including the ΔrecB strain) are not. Consistent with this observation, P1 was unable to form plaques on the putative ΔrecB transductants. Third, the Mitomycin C MIC of the putative ΔrecB transductants matched that of the parental ΔrecB strain (about 8-fold lower compared to recB+ strains).

The presence of the gyrA* FQ^{r} mutations was also confirmed by PCR amplification and sequencing of the quinolone resistance determining region (QRDR) from all strains. The genotypes matched expectations in all cases. The Cipro MICs of these ΔrecB gyrA* strains compared to the parental ΔrecB strain also suggested the presence of the gyrA* mutations (Table 4).

### Example 4

### Temperature Sensitive recB and recC Mutants Exhibit an Increased Sensitivity to Ciprofloxacin

In order to further demonstrate the role of RecBC(D) in the maintenance of stable ciprofloxacin resistance, the biological consequences of abrogating RecBC(D) activity was examined in the context of strains that had evolved resistance to low (35 ng/ml) levels of ciprofloxacin.

Stressful lifestyle adaptive mutation (SLAM) assays were performed in strain SK119 containing a temperature sensitive RecB mutation (Kushner, S., J. Bacteriol. 1213 (1974)), essentially as described in Cirz et al., (pending publication) and depicted in FIG. 3. Briefly, 1×10⁷ cells from three separate cultures were spread on to each of 8 LB plates containing 35 ng/ml ciprofloxacin. The plates were incubated for five days at 30° C. During that time, six colonies were picked by excising a 3 mm plug from the agar plate that was resuspended in 1 ml of 15% glycerol. Ten microliters of this resuspension was streaked out on a fresh plate containing 35 ng/ml ciprofloxacin. A single colony was picked from each of these six ciprofloxacin resistant strains as well as the parental strain, and the MIC was measured as described (Cirz et al., pending publication).

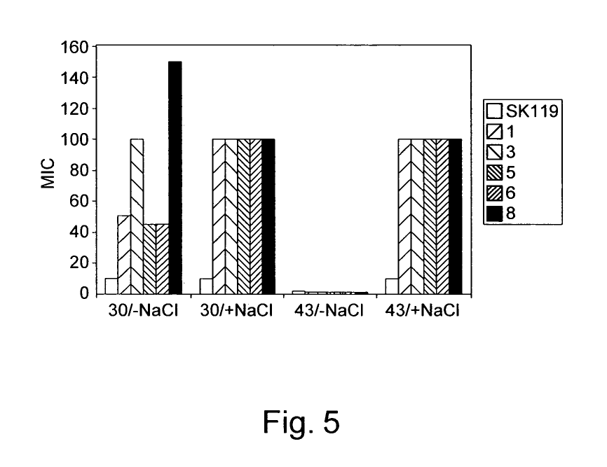

The MIC was examined under four different conditions: 30° C. and 43° C. in the presence or absence of NaCl. Media containing NaCl consisted of 10 g bacto tryptone, 5 g yeast extract, 5 g NaCl in 1 L of H₂O at pH 7.0. Media lacking NaCl was of the identical composition, but with no NaCl. These four conditions were examined, since the temperature sensitive phenotype is only observed under conditions of low salt (Kushner, S., J. Bacteriol. p 1213 (1974)). As indicated in FIG. 5, the MICs of the strains ranged from 50-150 ng/ml at the permissive temperature and at the non-permissive temperature in the presence of high salt. However, at the non-permissive temperature and low salt, the MICs of all six strains was dramatically shifted to 1 ng/ml.

These studies demonstrate that these strains are highly dependent on the presence of RecB activity to tolerate otherwise sublethal concentrations of ciprofloxacin. In addition, these data further establish that RecBC(D) and other components of the homologous recombination or recombination dependent DNA replication pathways, are required for the maintenance of stable ciprofloxacin resistance and, thus, represent important targets in the development of new drugs for the treatment of resistant strains.

### Example 5

### An Inhibitor of recBC(D) Increases the Ciprofloxacin Sensitivity of Resistant E. coli

To test the model that inhibition of RecB would significantly sensitize already resistant bacteria to ciprofloxacin, the effect of the λ_{gam} protein was examined. This protein is used by λ phage to inhibit E. coli RecB in order to prevent its cleavage of the phage genome during infection. To construct an arabinose-inducible expression system for the study of gam overexpression in E. coli, the gam gene from λ phage was amplified by PCR from strain PS6275 and cloned into the NdeI/XhoI sites of vector pBadAss resulting in vector pRTC0045. pRTC0045 and its corresponding empty vector control (pBadAss) were each transformed into E. coli strains RTC0086, RTC0110 and RTC0013 resulting in a total of 6 strains (Table 5).

TABLE 5
E. coli strains for lambda gam overexpression

| Strain | Relevant Genotype | Source |
|---|---|---|
| RTC0141 | ΔaraA::Gm^{R}, +pBadAss | Transform RTC0086 + |
| | | pBadAss |
| RTC0142 | ΔaraA::Gm^{R}, +pRTC0045 | Transform RTC0086 + |
| | | pRTC0045 |
| RTC0143 | ΔaraA::Gm^{R}, gyrA(S83L), +pBadAss | Transform RTC0110 + |
| | | pBadAss |
| RTC0144 | ΔaraA::Gm^{R}, gyrA(S83L), | Transform RTC0110 + |
| | +pRTC0045 | pRTC0045 |
| RTC0147 | ΔaraA::Gm^{R}, ΔrecB::Km^{R}, | Transform RTC0013 + |
| | +pBadAss | pBadAss |
| RTC0148 | ΔaraA::Gm^{R}, ΔrecB::Km^{R}, | Transform RTC0013 + |
| | +pRTC0045 | pRTC0045 |

To construct an arabinose-inducible expression system for the study of gam overexpression in P. aeruginosa, the araC gene, pBad promoter, gam gene or empty insert control, and rnnB terminator regions from pBadAss and pRTC0045 were amplified by PCR and each cloned into the ApaI/XbaI site of vector pBBR1 MCS-4 resulting in vectors pRTC0049 and pRTC0050, respectively. Both vectors were transformed into E. coli strain S17-1 and moved into P. aeruginosa strains ATCC 27853, RTC1013 and RTC1012 by conjugal mating resulting in a total of 6 strains (Table 6).

TABLE 6
P. aeruginosa strains for lambda gam overexpression

| Strain | Relevant Genotype | Source |
|---|---|---|
| RTC1014 | +pRTC0049 | Mate ATCC 27853 + pRTC0049 |
| RTC1017 | +pRTC0050 | Mate ATCC 27853 + pRTC0050 |
| RTC1015 | gyrA(S83l), +pRTC0049 | Mate RTC1013 + pRTC0049 |
| RTC1018 | gyrA(S83l), +pRTC0050 | Mate RTC1013 + pRTC0050 |
| RTC1016 | ΔrecB::Gm^{R}, +pRTC0049 | Mate RTC1012 + pRTC0049 |
| RTC1019 | ΔrecB::Gm^{R}, +pRTC0050 | Mate RTC1012 + pRTC0050 |

To determine the effect of gam overexpression on ciprofloxacin efficacy in E. coli, for each of the 6 strains an overnight culture was grown in Luria Broth (LB)+100 μg/ml ampicillin. 96-well plates containing 150 μl LB+100 μg/ml ampicillin, +/−ciprofloxacin, +/−arabinose were inoculated with approximately 5×10⁴ CFU of starting bacteria. Plates were covered with sterile, breathable filters and incubated for 18.5 hours at 37° C. After incubation, the OD₆₅₀ was read in a 96-well plate reader and used to determine ciprofloxacin IC50s, IC90s, and MICs in the presence and absence of gam (Table 7).

TABLE 7
Effect of gam expression on ciprofloxacin efficacy in E. coli

| | No Arabinose | | | 0.25% Arabinose | | |
|---|---|---|---|---|---|---|
| Strain | MIC (ng/ml) | IC50 | IC90 | MIC | IC50 | IC90 |
| RTC0141 | 35.0 | 15.3 | 28.1 | 35.0 | 18.5 | 32.8 |
| RTC0142 | 35.0 | 15.0 | 25.6 | 15.0 | 4.10 | 8.20 |
| RTC0143 | 750 | 257 | 515 | 750 | 428 | 725 |
| RTC0144 | 750 | 268 | 510 | 200 | 54.1 | 170 |
| RTC0147 | 15.0 | 2.3 | 4.6 | 15.0 | 2.8 | 5.1 |
| RTC0148 | 15.0 | 2.5 | 4.8 | 15.0 | 3.7 | 6.9 |

Overexpression of lambda gam resulted in an approximately 5-8 fold decrease in the ciprofloxacin IC50 for both wild-type E. coli (strain RTC0142) and E. coli containing a gyrA(S83L) mutation (strain RTC0144) relative to their empty vector control strains (strain RTC0141 and RTC0143, respectively). In contrast, overexpression of lambda gam in a strain lacking the RecB target (strain RTC0148) had no effect on the strain's ciprofloxacin sensitivity relative to the control, empty vector strain (RTC0147).

To determine the effect of lambda gam overexpression on ciprofloxacin efficacy in P. aeruginosa, for each of the 6 strains, an overnight culture was grow in LB+350 μg/ml carbenicillin. 96-well plates containing 150 μl LB+350 μg/ml carbenicillin, +/−ciprofloxacin, +/−arabinose were inoculated with approximately 5×10⁴ CFU of starting bacteria. Plates were covered with sterile, breathable filters and incubated for 18.5 hours at 37 C. After incubation, the OD650 was read in a 96-well plate reader and used to determine ciprofloxacin IC50s, IC90s and MICs in the presence and absence of gam (Table 8).

TABLE 8
Effect of gam expression on ciprofloxacin efficacy in P. aeruginosa

| | No Arabinose | | | 2.0% Arabinose | | |
|---|---|---|---|---|---|---|
| Strain | MIC (ng/ml) | IC50 | IC90 | MIC | IC50 | IC90 |
| RTC1014 | 400 | 84.5 | 177 | 400 | 81.7 | 172 |
| RTC1017 | 400 | 93.2 | 182 | 100 | 61.8 | 98.8 |
| RTC1015 | 11000 | 4100 | 7530 | 11000 | 2760 | 6640 |
| RTC1018 | 11000 | 3694 | 7122 | 5000 | 1630 | 3206 |
| RTC1016 | 25.0 | 9.2 | 19.7 | 25.0 | 12.9 | 22.7 |
| RTC1019 | 25.0 | 11.0 | 21.2 | 25.0 | 12.8 | 22.7 |

In P. aeruginosa, overexpression of lambda gam resulted in an approximately 2-4 fold decrease in the ciprofloxacin MIC for both wild-type P. aeruginosa (strain RTC1017) and P. aeruginosa containing a gyrA(S831) mutation (strain RTC1018) relative to their empty vector control strains (strain RTC1014 and RTC1015, respectively). In contrast, overexpression of lambda gam in a strain lacking the RecB target (strain RTC1019) had no effect on the strain's ciprofloxacin sensitivity relative to the control, empty vector strain (RTC1016).

### Example 6

### Target-Based Method of Identifying Small Molecule Inhibitors of recBC or recBCD

Small molecule inhibitors of RecBC(D) are identified by screening a library of chemical compounds for their ability to bind recombinant RecBC(D) using the Automated Ligand Identification System (ALIS), essentially as described in U.S. Pat. Nos. 6,721,665, 6,714,875, 6,694,267, 6,691,046, 6,581,013, 6,207,861, and 6,147,344. ALIS is a high throughput technique for the identification of small molecules that bind to proteins of interest. “RecBC(D)” is meant to indicate that one can screen either RecBC or RecBCD in any of the indicated steps.

Using this technique, recombinantly produced and purified RecBC(D) is combined with 5,000 pools of compounds, each pool containing approximately 5,000 compounds, each compound having a precise molecular structure that can be determined based upon its mass (and knowledge of the compounds present in the library). The RecBC(D) proteins and the compounds are mixed together for 30 minutes at room temperature to permit binding. The mixture is then rapidly cooled to trap bound complexes and subjected to rapid size exclusion chromatography (SEC). Small molecules that bind tightly to RecBC(D) and are co-excluded with RecBC(D) during SEC are then subjected to mass spectroscopic analysis to determine their masses. The mass of each compound is then used to determine its molecular structure. The corresponding structure is then resynthesized, and its ability to bind RecBC(D) is confirmed in a binding assay.

Confirmed binders are subsequently tested in a helicase assay to identify inhibitors of RecBC(D)-mediated helicase activity (Nature. 2003 Jun. 19; 423(6942):889-93; Eggleston NAR 24:1179-1186, 1996). The RecBCD complex encodes both a 5′-3′ (RecD) and a 3′-5′ (RecBC) helicase. recD mutants are still recombination proficient and are not hypersensitized to FQs (Example 1). In contrast, recB mutants are hypersensitized to FQs (Example 1) and are deficient in HR. Thus, in certain embodiments, inhibitors of RecBC are desired. The helicase assay is performed using a purified RecBC helicase fraction or a RecBC(D) (recD K177Q) mutant, as the K177Q mutation has been shown to disable the helicase activity of RecD. Compounds identified as inhibitors of the RecBC helicase activity are subjected to SAR to identify structurally diverse analogs with a range of potencies.

Compound series identified as binding RecBC(D) are tested for their ability to increase ciprofloxacin sensitivity in wild type gyrA and mutant gyrA(S83L) strains of E. coli MG1655. Each of these strains is treated with 35 ng/ml of ciprofloxacin in the presence or absence of various amounts of a compound identified as binding RecBC(D), and the MIC is determined. Compounds that result in lower MIC values are identified as compounds that inhibit RecB activity. To avoid false positives due to low permeability into cells or efficient elimination of compounds by efflux pumps, these assays are performed using strains and conditions that favor permeability into cells and that reduce the activity of efflux pumps by, for example, mutation or by the addition of inhibitors.

Analogs and derivatives of these compounds are synthesized using various techniques known in the art and further tested for their ability to reduce MIC value using an in vivo thigh challenge model, essentially as described in Andes and Craig, Antimicrob Agents Chemother. 46:1665-70 (2002)). Briefly, six week old, specific pathogen-free, female CD-1 mice are rendered neutropenic (neutrophil counts <100/mm³) by injecting 150 mg/kg cyclophosphamide intraperitoneally four days before infection and 100 mg/kg cyclophosphamide 24 hours before infection. Mueller-Hinton (MH) broth cultures inoculated from freshly plated bacteria are grown to logarithmic phase (OD580 of approximately 0.3) and diluted 1:10 in MH broth. Thigh infections are produced by injecting 0.1 ml volumes of the diluted broth cultures into halothane-anesthetized mice. Beginning two hours after infection (defined as time zero), mice are administered subcutaneous injections of either 0.5 mg/kg ciprofloxacin in the presence or absence of various amounts of a compounds being tested every 12 hours for three days. At each time point tested, both thighs from two sacrificed animals are removed and homogenized. Serial dilutions of thigh homogenates are plated on MH agar and MH agar containing about 10-80 ng/ml ciprofloxacin. After 24 hours, visible colonies are counted and excised from the plates to determine the total number of viable, ciprofloxacin-resistant cells. The remaining agar is homogenized in saline, and serial dilutions are plated in duplicate on LB agar to determine the total number of viable, ciprofloxacin-sensitive cells present. Compounds resulting in a reduced number of viable, ciprofloxacin-resistant or sensitive cells are identified as compounds that inhibit the activity of RecBC and are useful in treating ciprofloxacin resistant strains.

### Example 7

### Activity-Based Methods of Identifying Inhibitors

Small molecule inhibitors of RecB are identified based upon their ability to inhibit RecBC(D) ATPase activity. An in vitro assay for recombinant RecBC(D) ATPase activity is used to screen a library of small molecules for their ability to inhibit RecBC(D) activity.

In brief, His-tagged RecC or wild type RecC and wild-type RecB and RecD polypeptides are coexpressed in E. coli from bacterial expression vectors, such that the proteins form a native heterotrimer. Alternatively, RecBC(D) or mutant complexes such as RecBC(D)(K177Q) are expressed and purified in order to focus the assay on a particular activity of interest. These heterdimers or heterotrimers are then purified using a Ni-affinity columns or under other well-established conditions that maintain the heterotrimer. Recombinant expression of RecBC(D) has previously been described in Amundsen, S. K. et al., PNAS: 7399-7404 (2000) and Dillingham, M. S. et al., Nature: 893-897 (2003).

RecBC(D) ATPase activity is determined by measuring ATP hydrolysis using ³²P-ATP coupled to NADH oxidation, basically as described in Nucl. Acid. Res. 28:2324 (2000). Essentially, purified His-tagged RecBCD is incubated with ³²P-ATP, dsDNA, (NH₄)₂MoO₄, and malachite green. ATP hydrolysis is then determined based upon NADH oxidation, as measured at 660 nm absorbance.

To identify an inhibitor of RecBC(D) ATPase activity, a library of small molecules is screened using the NADH oxidation coupled ATP hydrolysis assay in a high throughput format, using 96-well plates. Recombinant RecBC(D) is placed into each well with the appropriate substrates. In addition, pools of different small molecules are added to each well (except a control well, to which no small molecules are added), and NADH oxidation is measured. Wells exhibiting decreased NADH oxidation are identified as containing a small molecule that inhibits RecBC(D) ATPase activity. Small molecules that were included in these well are then rescreened individually for their ability to inhibit RecBC(D) ATPase activity.

Compounds identified as inhibiting RecBC(D) ATPase activity are then tested for their ability to increase ciprofloxacin sensitivity in wild type gyrA and mutant gyrA(S83L) strains of E. coli. Each of these strains is treated with 35 ng/ml of ciprofloxacin in the presence or absence of various amounts of a compound, and the MIC is determined. Compounds that result in lower MIC values are identified as compound that increase ciprofloxacin sensitivity.

Analogs and derivatives of these compounds are synthesized using various techniques known in the art and further tested for their ability to reduce MIC value and in an in vivo thigh challenge model, as described above.

These methods are also used to obtain inhibitors of homologues of RecBCD such as the AddAB gene products in Bacillus subtilis and Bacillus anthracis and the RexAB proteins of Streptococcus pneumoniae.

### Example 8

### Deletion of the recB Gene Sensitizes Multiple Bacterial Species to Ciprofloxacin

To confirm that the ciprofloxacin sensitization effect of a recB mutation in E. coli extends to other bacteria, the recB gene was deleted from a variety of bacterial species, and the resulting strains were assayed for sensitivity to ciprofloxacin. Deletion of recB was carried out using standard techniques in E. coli(ATCC25922), K. pneumoniae (ATCC43816), P. aeruginosa (ATCC27853), B. anthracis (Sterne), and S. aureus (NARSA77). The genomic structures of the knockouts were confirmed by PCR. The ciproflaxacin MIC was determined in both wild type and recB mutant strains (Table 9).

TABLE 9
Ciprofloxacin MICs of ΔrecB strains

| | MIC wt | MIC KO |
|---|---|---|
| Species | (ng/ml) | (ng/ml) |
| E. coli | 35 | 5 |
| ATCC25922 | | |
| K. Pneumo. | 35 | 8 |
| ATCC43816 | | |
| P. aeruginosa | 400 | 100 |
| ATCC27853 | | |
| B. anthracis | 50 | 3 |
| Sterne | | |
| S. aureus | 200 | 40* |
| NARSA77 | | |

*rexAB; agar MIC

Deletion of recB from each of the bacterial species examined significantly sensitized the strains to ciprofloxacin, 4- to 16-fold depending upon the particular species. These results demonstrate that recB plays an important role in bacterial sensitivity to fluoroquine antibiotics, including ciprofloxacin, and indicate that an inhibitor of RecB is an effective combination treatment with fluoroquine antibiotics for the treatment of a broad range of bacterial infections.

### Example 9

### Deletion of recB Increases Ciprofloxacin Sensitivity of Klebsiella pneumoniae in an Animal Model

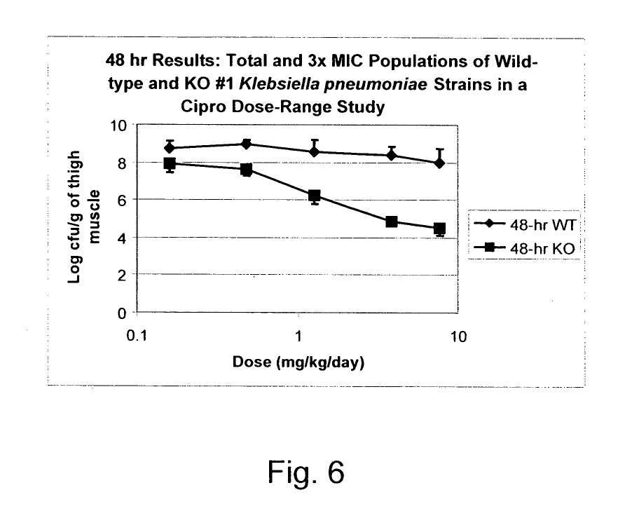

Ciprofloxacin dose response studies were performed using an immunocompetent murine thigh infection model of K. pneumoniae infection, in order to examine the effect of recB deletion. The thighs of mice were inoculated with 1-3×10⁷ CFU of strains of wild type or ΔrecB K. pneumoniae, and the mice were then treated at t=0 and 24 hours with doses ranging from 0.064-15 mg of ciprofloxacin per kg of body weight per day, with the dose fractionated for dosing every 24 h. Levels of bacteria in the thighs were measured by microbiologic assay at t=−2 and 0 hr for animals treated with saline and at 24 and 48 hours for animals treated either with saline or ciprofloxacin. Bio-fitness was measured at −2, 0, 24, and 48 hours. An exemplary graph of log CFU/gm of thigh at the 48 hour endpoint vs cipro dose (mg/kg/day) is shown in FIG. 6. *Carol: there is date information on FIG. 6. I recommend removing the date information.*

As is apparent from the graph in FIG. 6, there is a significantly greater reduction in CFU for the recB mutants relative to the wild type strain at every dose of cipro tested. This indicates that the sensitivity to ciprofloxacin that we see in vitro is also manifested as increased sensitivity to ciprofloxacin therapy in vivo. These studies indicate that deletion of recB results in enhanced ciprofloxacin sensitivity and more effective killing of K. pneumoniae in vivo, and demonstrate that inhibitors of the RecB helicase may be effectively used in combination with fluoroquinolones to treat K. pneumoniae and other bacterial infections. Furthermore, the enhanced killing of recB mutants as compared to wild type K. pneumoniae suggests that such a combination treatment will result in a faster cure and better efficacy for difficult to treat infections.

### Example 10

### Identification of recB Inhibitors that Sensitize Cells to Ciprofloxacin

High throughput screening methods were utilized to identify small molecule inhibitors of RecBC(D) that enhance the sensitivity of bacteria to ciprofloxacin. Briefly, a library containing approximately 110,000 synthetic compounds was selected from a potential library of 650,000 compounds (Discovery Partners International, San Diego, Calif.). These compounds were screened in multi-well plates containing membrane permeabilized E. coli grown in the presence of approximately 0.5× the minimal inhibitory concentration (MIC) of ciprofloxacin. Enhanced permeability was engineered with the use of a hypomorphic allele of IpxA (an essential gene, but quantitative reduction in the amount of lipid A produced by the cell with the hypomorphic allele significantly compromises the outer membrane, resulting in increased permeability to small molecules). Active compounds were subsequently re-assayed plus or minus ciprofloxacin (to distinguish antibiotics from ciprofloxacin sensitizing agents) and in an isogenic strain containing a deletion in rep, a non-essential helicase which has been shown to be synthetically lethal with recB or priA mutations. Active compounds that passed these filters were subsequently tested for their ability to kill E. coli K12 MG1655 Δrep (in order to assess their ability to enter E. coli with wild type permeability).

The initial screen identified approximately 40 compounds exhibiting ciprofloxacin sensitization, as determined by measuring both the 0.5× and 0.1×MICs. These compounds represented multiple structural scaffolds. While certain compounds displayed reduced or low permeability into bacteria, all of these compounds were able to enhance the sensitivity of bacteria to ciprofloxacin under conditions facilitating entry into the cell.

A structure-based search was performed on the remaining 640,000 molecules in the library to identify analogs having at least 70% Tanemoto similarity, and this resulted in 1052 additional compounds, permitting expansion of active scaffolds with analogs having similar structural and chemical properties. These compounds were put through the screening cascade outlined above. Numerous compounds were identified, and several discrete scaffold structures were revealed, including those represented by compounds of Formulas I, II, and III, as described further below.

One compound identified is shown below as Formula Ia, which falls within the scaffold shown generically as lb, wherein R is hydrogen, halo, cyano, phosphate, thio, alkyl, alkenyl, alkynyl, alkoxy, aminoalkyl, cyanoalkyl, hydroxyalkyl, haloalkyl, hydroxyhaloalkyl, alkylsulfonic acid, thiosulfonic acid, alkylthiosulfonic acid, thioalkyl, alkylthio, alkylthioalkyl, alkylaryl, carbonyl, alkylcarbonyl, haloalkylcarbonyl, alkylthiocarbonyl, aminocarbonyl, aminothiocarbonyl, alkylaminothiocarbonyl, haloalkylcarbonyl, alkoxycarbonyl, aminoalkylthio, hydroxyalkylthio, cycloalkyl, cycloalkenyl, aryl, aryloxy, heteroaryloxy, heterocyclyl, heterocyclyloxy, sulfonic acid, sulfonic alkyl ester, thiosulfate, or sulfonamido. 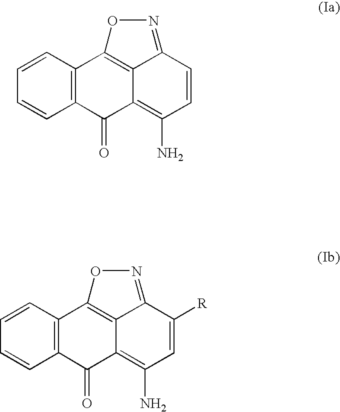
The compound of Formula Ia enhanced the sensitivity of E. coli to ciprofloxacin, providing a 10×MIC shift in ciprofloxacin responsiveness at 25 μM ciprofloxacin. Additional analogs were also identified that enhanced sensitivity to ciprofloxacin.

Another scaffold structure identified is represented generically in Formula IIa, wherein either A is nitrogen, and the other A is carbon . Specific compounds identified having this scaffold structure are shown in Formulas IIb and IIc. 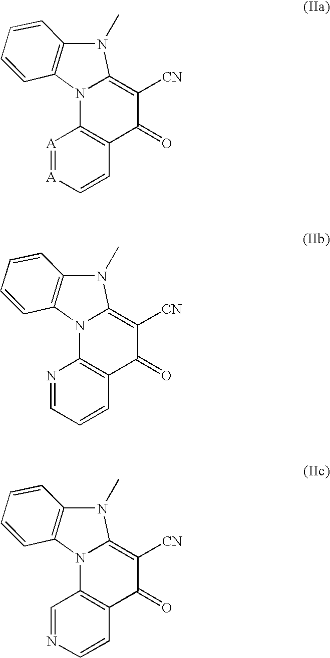
Each of these compounds enhanced the activity of ciprofloxacin at 25 μM.

Another scaffold identified during the screens is represented by the identified compound shown in Formula III. Compounds in this scaffold also enhanced ciprofloxacin sensitivity.

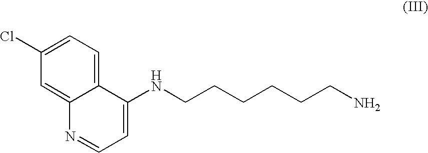

The results of the screen described above demonstrate the identification of a variety of structurally distinct compounds that sensitize cells to ciprofloxacin, consistent with these compounds being inhibitors of either recB or priA. These studies establish that the methods of the present invention can be successfully used to identify compounds that enhance the sensitivity of bacteria to fluoroquinolones. In addition, they demonstrate that a variety of chemical compounds having very different structural scaffolds share the functional characteristic of enhancing sensitivity of bacteria to fluoroquinolones.

All publications and patent applications mentioned in this specification are herein incorporated by reference to the same extent as if each individual publication or patent application was specifically and individually indicated to be incorporated by reference.

It will be apparent to one of ordinary skill in the art that many changes and modifications can be made thereto without departing from the spirit or scope of the appended claims.

1. A business method comprising:
identifying a compound that is effective as an antimicrobial or cytotoxic agent;
determining if a microorganism or cell is resistant to said compound, whereby said compound would have decreased market potential because of, at least in part, said resistance; and
selling said compound with an inhibitor of DNA repair, recombination, or replication.

2.-19. (canceled)

20. The method of claim 1 wherein the inhibitor modulates the activity of one or more polypeptides associated with DNA break repair or repair of stalled replication forks.

21. The method of claim 1 wherein the inhibitor is selected from the group consisting of: small molecules, peptides or mimetics thereof, polynucleotides, polypeptides, and antibodies and fragments thereof.

22. The method of claim 1 wherein the inhibitor is a small molecule capable of binding to a polypeptide selected from the group consisting of RecA, RecB, and PriA.

23. (canceled)

24. The method of claim 1 wherein said compound is not approved for use to treat one or more conditions due to undesirable side-effects associated with the therapeutic dosage.

25. The method of claim 1 wherein said compound is not used to treat one or more conditions due to higher cost as compared to alternative treatments.

26. The method of claim 1 wherein treatment with the compound in combination with the inhibitor reduces the required therapeutic dosage.

27. The method of claim 1 wherein the inhibitor reduces the therapeutic index of the compound.

28. A business method comprising:
identifying an antimicrobial or cytotoxic compound to which one or more cells are known to be resistant; and
selling said compound with an inhibitor of DNA repair, recombination, or replication.

29.-46. (canceled)

47. The method of claim 28 wherein the inhibitor modulates the activity of one or more polypeptides associated with DNA break repair or repair of stalled replication forks.

48. The method of claim 28 wherein the inhibitor is selected from the group consisting of: small molecules, peptides or mimetics thereof, polynucleotides, polypeptides, and antibodies and fragments thereof.

49. The method of claim 28 wherein the inhibitor is a small molecule capable of binding to a polypeptide selected from the group consisting of RecA, RecB, and PriA.

50. (canceled)

51. The method of claim 28 wherein the inhibitor reduces the therapeutic index of said compound.

52. A business method comprising:
identifying an antimicrobial or cytotoxic compound that is not approved by the Food and Drug Administration to treat one or more diseases or disorders due to undesired side effects; and
selling said compound with an inhibitor of DNA repair, recombination, or replication.

53. The method of claim 52 further comprising obtaining approval from the Food and Drug Administration to treat one or more of said diseases or disorders using said compound in combination with said inhibitor.

54.-67. (canceled)

68. The method of claim 52 wherein the inhibitor modulates the activity of one or more polypeptides associated with DNA break repair or repair of stalled replication forks.

69. The method of claim 52 wherein the inhibitor is selected from the group consisting of: small molecules, peptides or mimetics thereof, polynucleotides, polypeptides, and antibodies and fragments thereof.

70. The method of claim 52 wherein inhibitor is a small molecule capable of binding to a polypeptide selected from the group consisting of RecA, RecB, and PriA.

71. (canceled)

72. The method of claim 52 wherein said inhibitor reduces the therapeutic index of said compound.

73. A business method comprising:
identifying an inhibitor of DNA repair, recombination, or replication that sensitizes a microorganism or cell to a compound with antimicrobial or cytotoxic activity; and
selling said inhibitor for use in combination with said compound.

74.-84. (canceled)

85. The method of claim 73 wherein the inhibitor modulates the activity of one or more polypeptides associated with DNA break repair or repair of stalled replication forks.

86. The method of claim 73 wherein the inhibitor is selected from the group consisting of: small molecules, peptides or mimetics thereof, polynucleotides, polypeptides, and antibodies and fragments thereof.

87. The method of claim 73 wherein inhibitor is a small molecule capable of binding to a polypeptide selected from the group consisting of RecA, RecB, and PriA.

88. (canceled)

89. The method of claim 73 wherein said inhibitor reduces the therapeutic index of said compound.
